(19) United States
(12) Patent Application Publication
(10) Pub. No.: US 2024/0360851 A1
(43) Pub. Date: Oct. 31, 2024

(54) HYDRAULIC CYLINDER ASSEMBLY

(71) Applicant: Enerpac Tool Group Corp., Menomonee Falls, WI (US)

(72) Inventors: Kyle Michael Harvey, Waukesha, WI (US); Joseph Austin Morlote, Harrodsburg, KY (US); Eric Norquist, Whitefish Bay, WI (US); Daniel Escudero Alonso, Madrid, Madrid (ES); Celia Sánchez Santero, Aranjuez, Madrid (ES); Samantha Ann Teumer, Hartford, WI (US); Matthiew John Schleis, West Allis, WI (US); Ben Gall, Menomonee Falls, WI (US); Connor Joseph Sannito, Sturgeon Bay, WI (US)

(73) Assignee: Enerpac Tool Group Corp., Menomonee Falls, WI (US)

(21) Appl. No.: 18/681,978

(22) PCT Filed: Aug. 12, 2022
(86) PCT No.: PCT/US2022/040261

§ 371 Date: Feb. 7, 2024

Related U.S. Application Data
(60) Provisional application No. 63/232,519, filed on Aug. 12, 2021.
(60) Provisional application No. 63/284,465, filed on Nov. 30, 2021.
(60) Provisional application No. 63/336,034, filed on Apr. 28, 2022.
(60) Provisional application No. 63/337,461, filed on May 2, 2022.

(51) Int. Cl. F15B 15/14; F15B 15/18

(52) U.S. Cl. CPC F15B 15/1428; F15B 15/149; F15B 15/18

(57) ABSTRACT

A cylinder assembly, a system, and methods of operating a cylinder assembly and lifting a load. The assembly may generally include a housing; a hydraulic pump supported within the housing; a motor supported within the housing and operable to power the pump; a power source supported by the housing and operable to supply power to the motor; a cylinder coupled to the housing; a piston movably supported by the cylinder, the pump being operable to supply hydraulic fluid to the cylinder to move the piston to an advanced position; and a support member engageable with a work surface to support the assembly relative to the work surface, the support member being coupled to the cylinder. The assembly may have a maximum rated force capacity of at least 15 tons (t). The cylinder assembly may be supportable by an operator for movement of the cylinder assembly relative to the work surface

### RELATED APPLICATIONS

The present application claims priority to co-pending U.S. Patent Application No. 63/232,519, filed Aug. 12, 2021; U.S. Patent Application No. 63/284,465, filed Nov. 30, 2021; U.S. Patent Application No. 63/336,034, filed Apr. 28, 2022; and U.S. Patent Application No. 63/337,461, filed May 2, 2022; the entire contents of all of which are hereby incorporated by reference.

### FIELD

The present disclosure relates to piston-cylinder units and, more particularly, to a hydraulic cylinder assembly.

### SUMMARY

A piston-cylinder unit, such as a hydraulic piston-cylinder unit, a pneumatic piston-cylinder unit, etc., uses pressurized fluid to apply large forces. In particular, application of the pressurized fluid to a piston advances (or may retract) the piston relative to a cylinder.

A hydraulic piston-cylinder unit is usually driven by a separate motor-driven pump supplying hydraulic fluid through a hose connected to the unit. The user is required to transport the pump, hoses, etc., along with the piston-cylinder unit, to/from and around a work site. Additionally, access to electrical power or hydraulics is required to drive the pump and thereby the separate piston-cylinder unit.

In one independent aspect, a cylinder assembly may generally include a housing; a hydraulic pump supported within the housing; a motor supported within the housing and operable to power the pump; a power source supported by the housing and operable to supply power to the motor; a cylinder coupled to the housing and having a first end and an opposite second end; a piston movably supported by the cylinder, the pump being operable to supply hydraulic fluid to the cylinder to move the piston through the second end at least from a retracted position to an advanced position; and a support member engageable with a work surface to support the cylinder assembly relative to the work surface, the support member being coupled to the cylinder. The cylinder assembly may have a maximum rated force capacity of at least 15 tons (t). The cylinder assembly may be supportable by an operator for movement of the cylinder assembly relative to the work surface.

As used herein, “maximum rated force capacity” is generally understood to be the maximum capacity of force that the cylinder assembly is capable of exerting upon an object. The amount of force a hydraulic cylinder can generate is generally equal to the hydraulic pressure times the “effective area” of the cylinder.

In another independent aspect, a cylinder assembly may generally include a controller including an electronic processor supported in a housing and configured to control a function of the cylinder assembly; and an external control device configured to communicate with the controller to control the function.

In yet another independent aspect, a cylinder assembly may generally include a first support member selectively couplable with a cylinder, the first support member having a first support configuration and including a base plate supportable on a work surface to support the cylinder assembly on the work surface, the base plate being couplable to the first end of the cylinder; a second support member selectively couplable with the cylinder, the second support member having a second support configuration different than the first support configuration; and a coupling assembly configured to selectively couple the cylinder and one of the first support member and the second support member.

In a further independent aspect, a cylinder assembly may generally include a valve block supported in a housing and defining a passage selectively in fluid communication between a pump and a cylinder, the pump being connected to and supported on the valve block.

In another independent aspect, a cylinder assembly may generally include a power unit including a housing, a hydraulic pump supported within the housing, a motor supported within the housing and operable to power the pump, a power source supported by the housing and operable to power to the motor; a piston-cylinder unit including a cylinder having a first end and an opposite second end, and a piston movably supported by the cylinder, hydraulic fluid being suppliable to the cylinder to move the piston through the second end at least from a retracted position to an advanced position; and a coupling mechanism including a support member couplable to the power unit and to the piston-cylinder unit, the support member being engageable with a work surface to support the power unit and the piston-cylinder unit relative to the work surface, a hydraulic coupling fluidly connectable between the pump and the cylinder, when connected, the pump being operable to supply hydraulic fluid to the cylinder to move the piston through the second end, and a connector connectable between the housing and the cylinder.

In yet another independent aspect, a cylinder assembly may generally include a cylinder coupled to a housing and having a first end provided by an end wall and an opposite, second end, an inlet opening being defined through the end wall; and a manifold having a body defining a passage in fluid communication with a pump and a port communicating with the passage; the first end of the cylinder directly engaging the manifold to fluidly connect the inlet opening and the port thereby placing the passage and the chamber in fluid communication.

In a further independent aspect, a method of operating a cylinder assembly may be provided. The method may generally include selectively coupling a cylinder and one of a first support member and a second support member, the first support member having a first support configuration and including a base plate supportable on a work surface to support the cylinder assembly on the work surface, the base plate being couplable to a first end of the cylinder, the second support member having a second support configuration different than the first support configuration; when the base plate is connected to the cylinder, operating the cylinder assembly in a lifting configuration to lift a load; and, when the second support member is coupled to the cylinder, operating the cylinder assembly in a second operating configuration.

In another independent aspect, a method of lifting a load may be provided. The method may generally include providing a cylinder assembly including a housing, a base plate to support the cylinder assembly on a work surface, a hydraulic pump supported within the housing, a motor supported within the housing and operable to power the pump, a power source supported by the housing and operable to supply power to the motor, a cylinder coupled to the housing and having a first end and an opposite second end, the cylinder being coupled to the base plate, and a piston movably supported by the cylinder; connecting the cylinder assembly to a jack stand, the jack stand including a frame and a load support movable relative to the frame between a lowered position and a lifted position, the load support being operable to support a load to be lifted, connecting including connecting the housing to the frame, and connecting the piston to the load support; operating the motor to cause the pump to supply hydraulic fluid to the cylinder to move the piston relative to the cylinder from a retracted position to an advanced position to move the load support relative to the frame from the lowered position to the lifted position; holding the load support in the lifted position; and disconnecting the cylinder assembly from the jack stand.

In yet another independent aspect, a system may generally include a cylinder assembly including a housing, a hydraulic pump supported within the housing, a motor supported within the housing and operable to power the pump, a power source supported by the housing and operable to supply power to the motor, a first piston-cylinder unit including a first cylinder coupled to the housing and having a first end and an opposite second end, and a first piston movably supported by the first cylinder, the pump being operable to supply hydraulic fluid to the first cylinder to move the first piston through the second end at least from a retracted position to an advanced position, a support member engageable with a work surface to support the cylinder assembly relative to the work surface, and a controller including an electronic processor supported in the housing and configured to control a function of the cylinder assembly; a second piston-cylinder unit including a second cylinder having a first end and an opposite second end, and a second piston movably supported by the second cylinder, hydraulic fluid being supplied to the second cylinder to move the second piston through the second end at least from a retracted position to an advanced position; and an external control device configured to communicate with the controller to control the function of the cylinder assembly, and control supply of hydraulic fluid relative to the second cylinder to move the second piston relative to the second cylinder.

In a further independent aspect, a cylinder assembly may generally include a frame including a base plate supportable on a work surface to support the cylinder assembly on the work surface, and an upper frame member extending from the base plate; and a housing connected to the frame.

Other independent aspects of the disclosure may become apparent by consideration of the detailed description, claims and accompanying drawings.

### BRIEF DESCRIPTION OF THE DRAWINGS

FIG. 1 is a perspective view of a cylinder assembly.

FIG. 2 is a front view of the cylinder assembly of FIG. 1, with the battery removed and illustrating the battery receptacle.

FIG. 3 is a perspective view of the portion of the cylinder assembly shown in FIG. 1, illustrated with the housing and the battery removed.

FIG. 4 is a top view of the portion of the cylinder assembly shown in FIG. 3.

FIG. 5 is a cross-sectional view of the portion of the cylinder assembly shown in FIG. 1, illustrated with the housing removed.

FIG. 6 is a side view of a portion of the cylinder assembly shown in FIG. 5, illustrating the power unit, the valve assembly, and the reservoir.

FIG. 7 is a cross-sectional view of the portion of the cylinder assembly shown in FIG. 6.

FIG. 8 is another perspective view of a lifting system including a number of cylinder assemblies of FIG. 1.

FIG. 9 is another perspective view of another lifting system including a cylinder assembly of FIG. 1.

FIG. 10 is perspective view of the lifting system shown in FIG. 9, illustrating the toe jack.

FIGS. 11A-11C are views of constructions of the cylinder assembly shown in FIG. 1.

FIGS. 12A-12C are views of constructions of the cylinder assembly shown in FIG. 77.

FIG. 13 includes perspective views of a lifting system including a number of cylinder assemblies of FIG. 12A.

FIGS. 14-15 are perspective views of an alternative construction of a cylinder assembly, illustrated oriented generally vertically and generally horizontally, respectively.

FIG. 16 is a perspective view of the cylinder assembly of FIG. 14, illustrated with the housing removed.

FIGS. 17-18 are perspective views of the cylinder assembly of FIG. 14, illustrated with a skid bar and a skid plate, respectively.

FIG. 19 is a front perspective view of another alternative construction of a cylinder assembly.

FIG. 20 is another perspective view of the cylinder assembly of FIG. 19.

FIG. 21 is a front view of the cylinder assembly of FIG. 19, illustrated with the battery removed and showing the battery receptacle.

FIG. 22 is a perspective view of the cylinder assembly of FIG. 19, illustrated with the housing, the pendant, the roll cage, and the battery receptacle removed.

FIG. 23 is a top view of the cylinder assembly as shown in FIG. 22.

FIG. 24 is a perspective view of the cylinder assembly of FIG. 19, illustrated with a mounting belt and supported on a jack stand.

FIGS. 25A-25B are perspective views of different pin puller assemblies including cylinder assemblies.

FIG. 26 is another perspective view of the pin puller assembly of FIG. 25A.

FIG. 27A-27C are views illustrating the connection assembly for a cylinder assembly, such as the cylinder assembly of FIG. 25A.

FIGS. 28-29 are perspective views of the pin puller assembly of FIG. 25A, illustrated with one or more portions removed.

FIGS. 30-31 are perspective views of the pin puller assembly of FIG. 26A, illustrated with one or more portions removed.

FIGS. 32A-32B are side views of the cylinder assembly, illustrated in use with a pin pulling system and as a lifting or jacking cylinder, respectively.

FIG. 33 is a perspective view of an alternative construction of a cylinder assembly.

FIG. 34 is a side view of the cylinder assembly of FIG. 33.

FIG. 35 is a perspective view of a portion of the cylinder assembly of FIG. 33, illustrated with the housing and the power unit removed.

FIGS. 36A-36B are perspective views of the cylinder assembly of FIG. 33, illustrated with the housing removed to show alternative arrangements of internal components.

FIG. 37 is a perspective view of a lifting system including a number of the cylinder assemblies shown in FIG. 33.

FIGS. 38A-38B are perspective views of lifting assemblies including a cylinder assembly shown in FIG. 33, illustrated in a lifting operation.

FIG. 39 is a perspective view of an alternative construction of a cylinder assembly.

FIG. 40 is a side view of the cylinder assembly of FIG. 39.

FIG. 41 is a perspective view of the cylinder assembly of FIG. 39, illustrated with a housing half removed.

FIG. 42 is a side cross-sectional view of the cylinder assembly of FIG. 39, illustrated with the housing removed.

FIG. 43 is a perspective view of an alternative construction of a base plate, a power unit, a piston-cylinder unit, and a valve assembly for a cylinder assembly.

FIG. 44 is a perspective view of the base plate, a portion of the power unit, and the valve assembly shown in FIG. 43.

FIGS. 45A-45B are side cross-sectional views of the piston-cylinder unit shown in FIG. 43.

FIG. 46 is a top perspective view of the base plate, a portion of the power unit, and the valve assembly shown in FIG. 44.

FIG. 47 is a top perspective view of the base plate shown in FIG. 43.

FIGS. 48-49 are views of an alternative construction of a portion of the power unit shown in FIG. 43, illustrated with the base plate and the valve assembly.

FIGS. 50A-50B are perspective views of another alternative construction of a cylinder assembly, illustrating connection of a piston-cylinder unit and a power unit.

### DETAILED DESCRIPTION

Before any independent embodiments are explained in detail, it is to be understood that the disclosure is not limited in its application to the details of construction and the arrangement of components set forth in the following description or illustrated in the following drawings. The disclosure is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10% or more) of an indicated value.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

The embodiment(s) described below and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

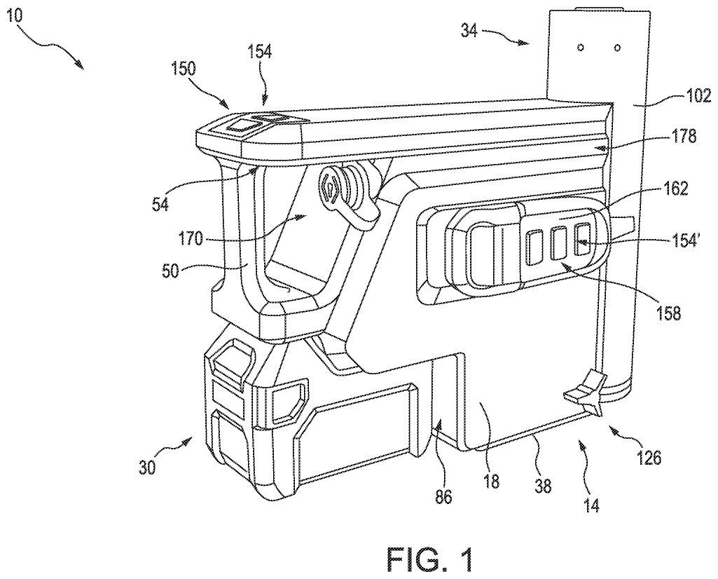

The figures illustrate constructions of a cylinder assembly 10 which is self-contained and powered by an integrated, onboard power unit. In some independent aspects, the cylinder assembly 10 generally includes (see, e.g., FIGS. 1-7) a frame 14, a housing 18, an onboard power unit with a pump 22, a motor 26, and a power source (e.g., a battery pack 30), and a piston-cylinder unit 34. In some constructions (not shown), the onboard power unit may not include one or more of the pump 22, the motor 26, and/or the power source.

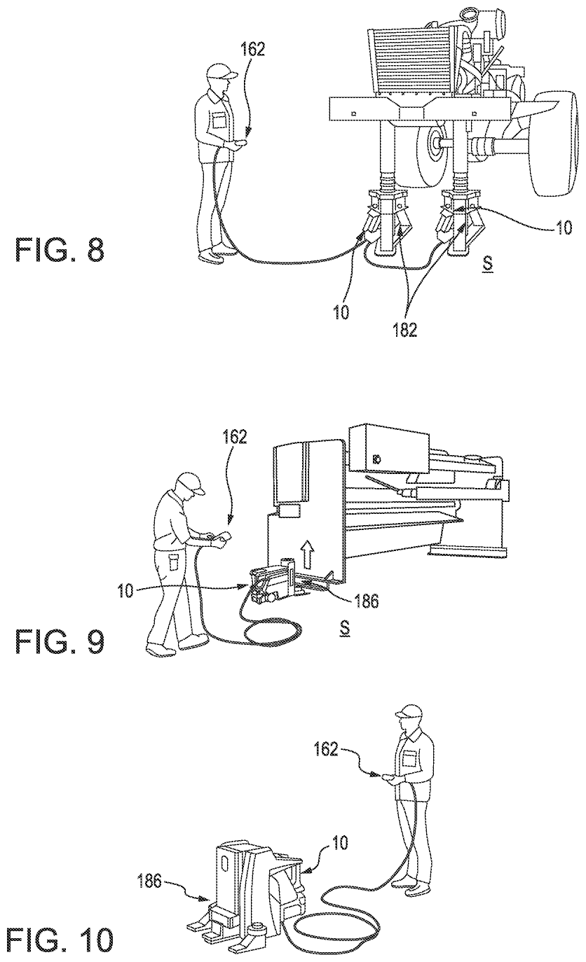

FIGS. 8-10 illustrate the cylinder assembly 10 included in various lifting systems. The illustrated cylinder assembly 10 has a weight of about 27 pounds (lbs.) to about 40 lbs., and a package size with a length from the front of the housing 18 to the piston axis P of about 10 inches (in.) to about 14 in. (about 13.3 in., as shown), a housing height of about 9 in. to about 11 in. (10.5 in., as shown) and a housing width of about 5 in.

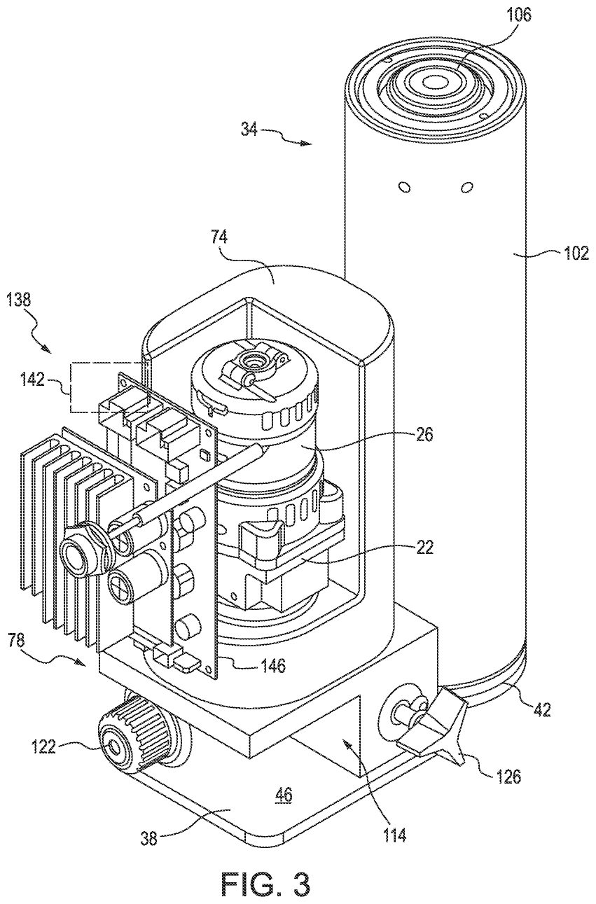

As shown in FIGS. 3-5, the frame 14 generally includes a support member, such as a base plate 38 supportable on a work surface S, to support the cylinder assembly 10 relative to the work surface S. The illustrated base plate 38 has a generally circular cylinder support portion 42, supporting the piston-cylinder unit 34, tapering to a generally rectangular power unit support portion 46, supporting the power unit.

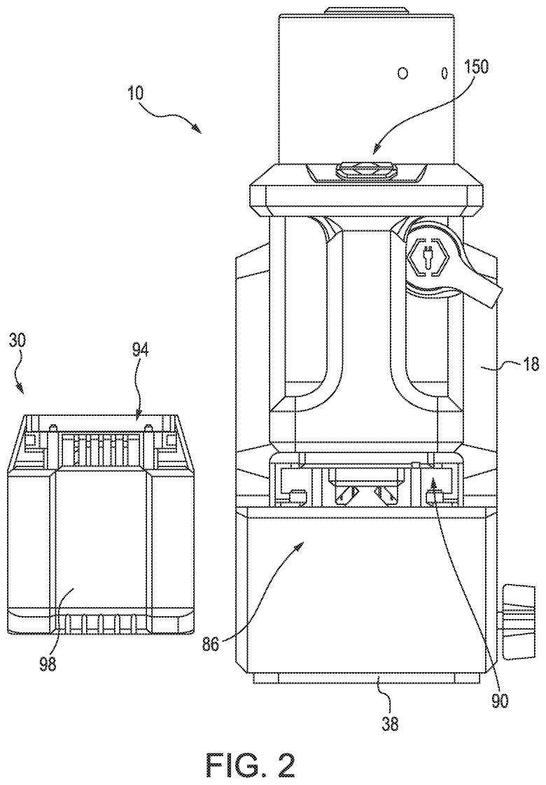

The illustrated cylinder assembly 10 includes (see FIGS. 1-2) at least one handle portion engageable by the operator to support the cylinder assembly 10, for example, for transport to, from or around a work location, relative to the work surface S, etc. In the illustrated construction, a handle portion is provided on the housing 18, for example, by a handle 50 and/or by a grip portion 54 recessed into the housing 18. The edges of the housing 18 may have a scallop or undercut (not shown) to provide the grip portion 54.

FIGS. 3-5 illustrate a potential arrangement of internal components of the cylinder assembly 10. The pump 22 and the motor 26 are illustrated in FIG. 3-7. Because the power unit (the pump 22, the motor 26, etc.) is integrated with the piston-cylinder unit 34, these power unit components are optimized (e.g., capacity, size, etc.) for use with the piston-cylinder unit 34.

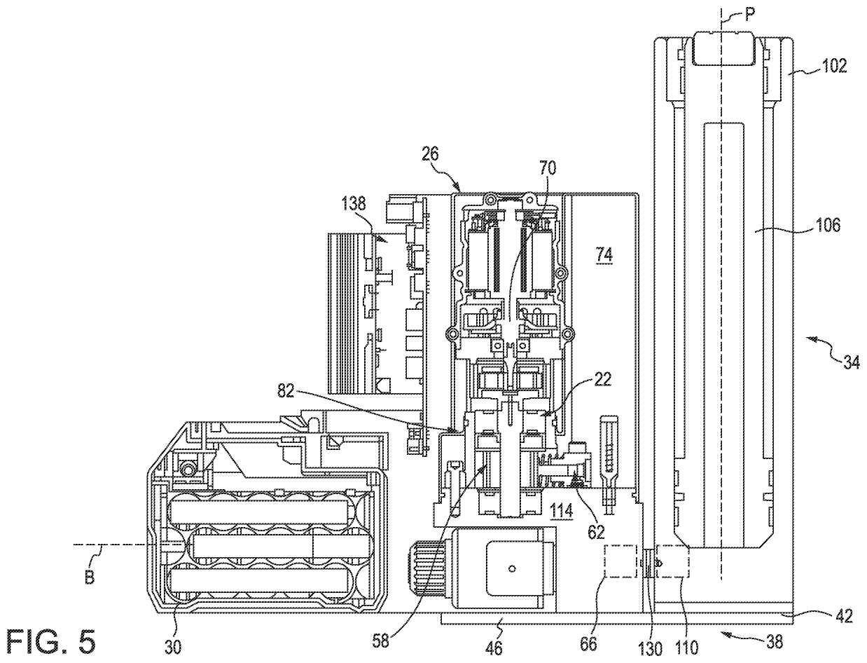

In the illustrated construction, the pump 22 and the motor 26 are positioned in the housing 18 and supported on the base plate 38 (e.g., the power unit portion 46) with the motor 26 positioned above and supported on the pump 22. In the illustrated construction, the pump 22 is a hydraulic pump and has (see FIG. 5) a pump mechanism 58 with a pump inlet 62 and a pump outlet 66 (see FIG. 7). The illustrated motor 26 is an electric motor powered by an electrical power source (e.g., the battery pack 30). The motor 26 includes a drive shaft 70 driving the pump 22.

The illustrated pump 22 includes a micro-hydraulic pump and may have a piston with a diameter of between about 4 millimeters (mm; about 0.157 in.) and about 8 mm (about 0.315 in.), with a flow rate of between about 15 cubic inches per minute (in.³/min) and about 40 in.³/min (e.g., 18 in.³/min at full load), and a pressure output of up to about 10,000 pounds per square inch (psi). In some constructions, the micro-hydraulic pump may include a multi-stage pump (see, e.g., FIGS. 8B-8C) with more than one piston, each with the same or different diameter.

In other constructions, the micro-hydraulic pump 22 may have a piston (or pistons) with a different diameter (e.g., up to about 3 mm, between about 30 mm and about 50 mm). The micro-hydraulic pump 22 may also produce a different flow rate (e.g., up to about 65 in³/min) or pressure output (e.g., between about 3,500 psi and about 10,000 psi).

The cylinder assembly 10 also includes a reservoir 74 for holding hydraulic fluid and a valve assembly 78 for controlling the flow of hydraulic fluid between the reservoir 74, the pump 22, and the piston-cylinder unit 34. In the illustrated construction, one portion of the reservoir 74 is between the piston-cylinder unit 34 and the pump 22 and the motor 26, and another portion of the reservoir 74 extends alongside the pump 22 and the motor 26. The illustrated reservoir 74 partially surrounds the pump 22 and the motor 26, providing a relatively larger reservoir 74.

As shown in FIGS. 5-7, the reservoir 74 defines an opening 82, and a portion of the pump 22 extends through the opening 82. The pump inlet 62 communicates with the reservoir 74, and, in the illustrated construction, at least a portion of the pump mechanism 58 is positioned in the reservoir 74.

The cylinder assembly 10 uses hydraulic oil formulated for pumps (e.g., having the desired volumetric efficiency, heat transfer, cavitation prevention, additives to limit or prevent sludge, rust, oxidation, foam, etc.). In other constructions (not shown), the cylinder assembly 10 may use different types of hydraulic fluid, such as, for example, a different hydraulic oil, mineral oil, etc., or a different fluid, such as, for example, air (e.g., an air cylinder powered by an onboard compressed air pump).

The reservoir 74 may include a shell housing a flexible bladder (not shown) to facilitate use of the cylinder assembly 10 in multiple orientations. The reservoir 74 may include a fill cap (not shown) within or extending from the housing 14 to receive hydraulic fluid into the reservoir 74.

As shown in FIGS. 1-2, the housing 18 defines, at the front bottom, a battery receptacle or compartment 86 into which the battery pack 30 is received. As shown, the battery pack 30 fits underneath the housing 18 and creates a flat front face for the cylinder assembly 10. The battery 30 is installed and removed from the compartment 86 along an insertion axis B.

The housing 18 includes (see FIG. 2) a support operable to mechanically support the battery pack 30 on the housing 18 and to electrically connect the battery pack 30 to an electrical circuit (not shown) in the housing 18. The support includes an interface 90 within the compartment 86 to provide the mechanical and electrical connection with the battery pack 30 (e.g., with a complementary pack interface 94 on the pack housing 98).

The illustrated battery pack 30 is a removable and rechargeable power tool battery pack and is operable to power electrical components (e.g., the motor 26, electronic components, etc.) of the cylinder assembly 10. The battery pack 30 may be connectable and operable to power various different electric-powered devices, power tools (e.g., a hydraulic torque wrench, a hydraulic flange splitter, a driver, among others).

The illustrated battery pack 30 includes one or more battery cells arranged to provide a nominal voltage and capacity of the battery pack 30. For example, the battery pack 30 may be a 54-volt battery pack and may include fourteen (14) Lithium-ion (Li-ion) battery cells. In other constructions, the battery pack 30 may include fewer or more battery cells arranged to have a different nominal voltage or capacity. The battery cells may have a chemistry other than Li-ion such as, for example, Nickel Cadmium (NiCd), Nickel Metal-Hydride (NiMH), etc.

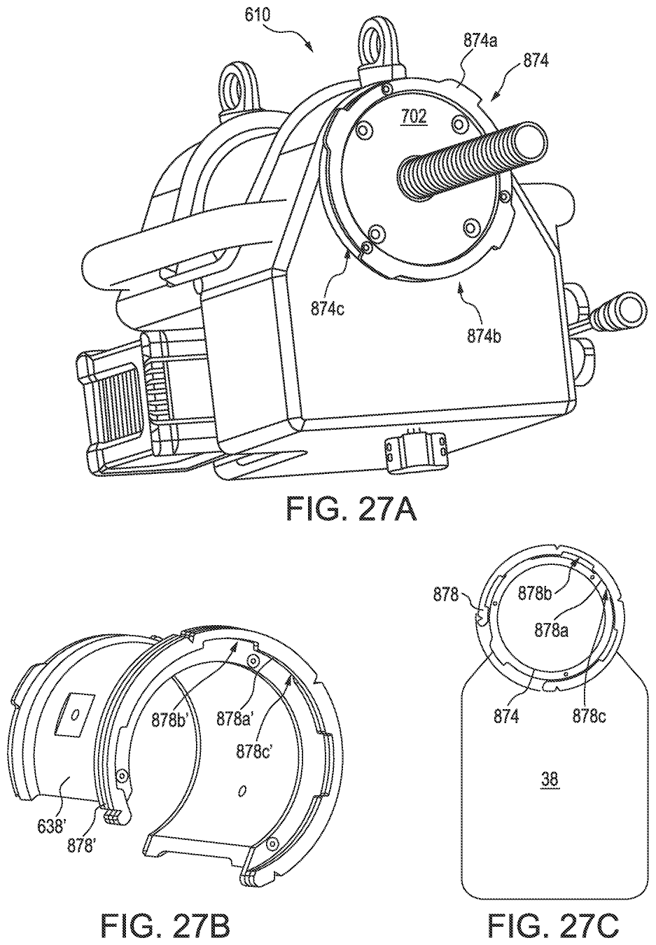

As shown in FIG. 5, the piston-cylinder unit 34 includes a cylinder 102 and a piston 106 supported for movement relative to the cylinder 102, with the closed end of the cylinder 102 connected to the cylinder support portion 42 of the base plate 38, for example, by fasteners (not shown). As described below, in other constructions (see, e.g., FIGS. 27A-27C), the base plate 38 may be removably coupled to the cylinder 102.

The illustrated piston-cylinder unit 34 is a single-acting unit, and the cylinder 102 has (see FIG. 5) a port 110 in fluid communication with a pump outlet 66. Through the supply of hydraulic fluid through the port 102, the pump 22 causes the piston 106 to advance and retract along a piston axis P through the open end of the cylinder 102. In other constructions (not shown), the piston-cylinder unit 34 may be a double-acting unit having another cylinder port communicating with the chamber on the other side of the piston 106.

In the illustrated construction (see FIG. 5), the battery insertion axis B and the piston axis P are arranged substantially transverse (e.g., perpendicular). The axes B, P lie in a plane (illustrated by the sheet of FIG. 5), and the plane intersects the pump 22, the motor 26, the piston-cylinder unit 34, the battery pack 30, and the reservoir 74.

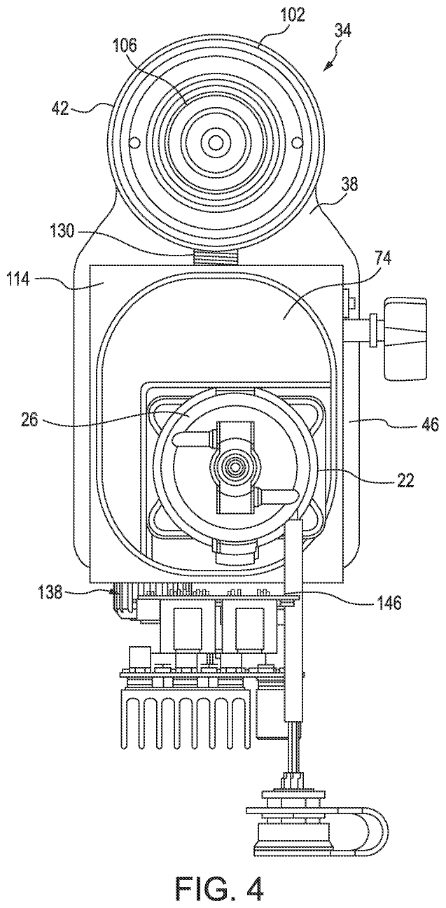

The valve assembly 78 includes a valve block 114 mounted on the power unit support portion 46 of the base plate 38. The reservoir 74 (see FIGS. 3-4) has a base with an oval shape supported on (e.g., bolted to) the valve block 114. The pump mechanism 58 extends into the reservoir 74 and is mounted on the valve block 114. As mentioned above, the motor 26 is supported on the pump 22B. The power unit (i.e., the pump 22 and the motor 26) and the reservoir 74 are supported on the valve block 114 and, therethrough, on the power unit support portion 46 of the base plate 38.

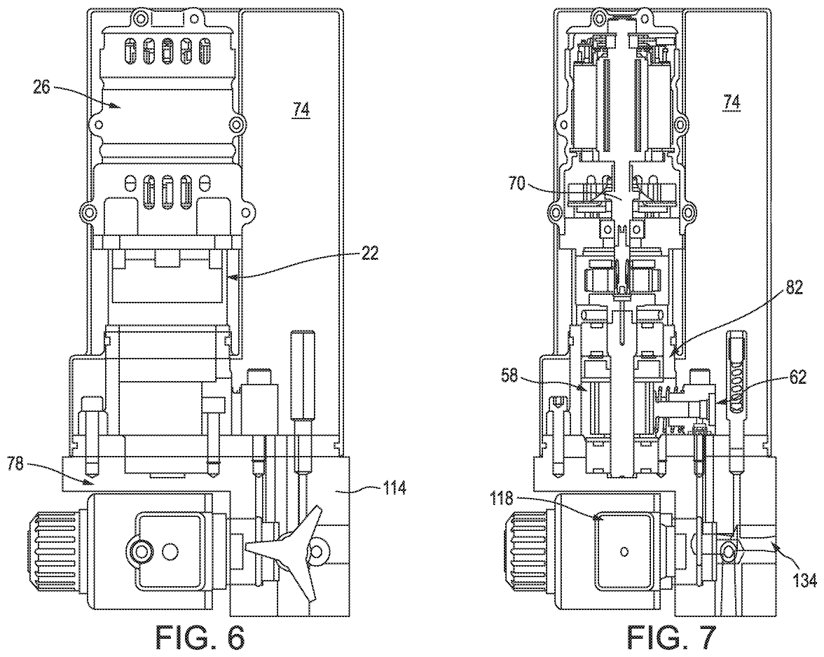

The illustrated valve block 114 provides a manifold defining (see FIGS. 6-7) one or more passages selectively in fluid communication between the pump 22 and the cylinder 102. The valve assembly 78 includes a solenoid valve control system 118 with a valve actuator 122 and a relief valve actuator 126, extending from the side of the housing 18. The relief valve actuator 126 allows a user to manually control the speed at which the piston 106 is lowered by controlling the rate at which hydraulic fluid is “dumped” from the cylinder 102. A conduit 130 connects (see FIG. 5) the valve block port 134 (providing the pump outlet 66) to the cylinder port 110.

A controller 138 (see FIG. 3), supported in the housing 18, is configured to control operation of the cylinder assembly 10 and its components. The controller 138 includes an electronic processor 142 mounted on a printed circuit board (PCB) 146.

The controller 138 is electrically and/or communicatively connected to a variety of modules or components of the cylinder assembly 10. The controller 138 includes a plurality of electrical and electronic components that provide power, operational control, and protection to the components and modules within the controller 138 and/or the cylinder assembly 10. For example, the controller 138 includes, among other things, the electronic processor (a programmable electronic microprocessor, microcontroller, or similar device), a memory (not shown), and an input/output (I/O) interface (not shown). The electronic processor is communicatively coupled to the memory and the I/O interface.

The controller 138 may be implemented in several independent controllers each configured to perform specific functions or sub-functions. Additionally, the controller 138 may contain sub-modules that include additional electronic processors, memory, or application specific integrated circuits (ASICs) for handling communication functions, processing of signals, and application of the methods listed below. In other embodiments, the controller 138 includes additional, fewer, or different components.

The memory is, for example, a non-transitory, machine-readable memory. The memory includes, for example, one or more non-transitory machine-readable media, a program storage area, and a data storage area. The program storage area and the data storage area can include combinations of different types of memory, such as read-only memory (ROM) and random access memory (RAM). In some embodiments, data is stored in a non-volatile random-access memory (NVRAM) of the memory. Various non-transitory computer readable media, for example, magnetic, optical, physical, or electronic memory may be used.

In the illustrated embodiment, the memory includes an input controller engine (not shown; for example, software or a set of computer-readable instructions that determines functions to be executed in response to inputs) and cylinder assembly functions (for example, software or a set of computer-readable instructions that provide functionality to the cylinder assembly 10).

The electronic processor is communicatively coupled to the memory and executes software instructions that are stored in the memory, or stored in another non-transitory computer readable medium such as another memory or a disc. The software may include one or more applications, program data, filters, rules, one or more program modules, and other executable instructions. In some embodiments, the memory stores predetermined functions, such as, for example, a calibration function (e.g., displaying options to a user and executing functionality to allow a user to calibrate the cylinder assembly 10) as well as other functions that are executed to provide cylinder assembly functionality, within the program storage area.

The I/O interface is communicatively coupled to components external to the controller 138 and coordinates the communication of information between the electronic processor and other components of the cylinder assembly 10. In illustrated examples, information received from an input component, an external device, etc. is provided to the electronic processor to assist in determining functions to be executed and outputs to be provided. The determined functionality is executed with the electronic processor with the software located the memory.

The cylinder assembly 10 may include one or more sensors (not shown) operable to sense a characteristic of the cylinder assembly 10. For example, the sensors may include a stroke sensor (e.g., a wire stroke sensor), a fluid pressure sensor, a tilt/movement sensor, a temperature sensor, etc. The controller 138 is connected to and communicates with (e.g., receives measurement signals from) the sensor(s). The controller 138 actively and independently controls (e.g., without operator input) one or more functions or operations of the cylinder assembly 10 based on information from the sensor(s). For example, the controller 138 applies feedback loops to automatically control the function(s) and/or operation(s) within certain limits or thresholds.

The illustrated cylinder assembly 10 includes (see FIGS. 1-2) an integrated user interface device 150 positioned on the housing 18. The interface device 150 includes a user input device (e.g., one or more buttons 154 (two shown), keys, a touch screen, etc.) configured to receive one or more inputs (e.g., a selection, a command, etc.) from a user and may also include a user feedback or output device (not shown) configured to communicate, display, etc. conditions or data associated with the cylinder assembly 10.

Inputs to the interface device 150 are communicated to the controller 138 to execute selected cylinder assembly functions and/or operations. For example, the user input device may include a power button, a “pair” button for use in wirelessly connecting the cylinder assembly 10 to an external device, a “select” button, etc. The user input device may also provide integrated controls for the piston-cylinder unit 34 (e.g., an “advance” button to advance the piston 106, a “retract” button to retract the piston 106, etc.).

Communication components (not shown) are on the PCB 146 and are configured to communicate with external devices (e.g., an external control device 158 (a smart phone, a tablet, a computing device, a dedicated system control device 162, 166), a data collection device, a pump, a cylinder, another cylinder assembly 10, a tool, etc.). In illustrated constructions, the cylinder assembly 10 includes a remote control device 158 configured to control operation of the cylinder assembly 10 and/or the system of multiple cylinder assemblies 10. With the remote control device 158, a user may be able to be out from under and/or away from any potential impact from the load. The cylinder assembly 10 may provide intelligent communication between cylinder assemblies 10 and the remote control device 158 for coordinated and synchronous lifting.

The cylinder assembly 10 includes (see FIGS. 1-2) a controller area network (CAN) bus 170 (e.g., an input port) configured for wired communication with an external device or devices (e.g., a wired pendant 162 for remote control of the cylinder assembly 10B) via a cord 174 (see FIGS. 9-11). A cord wrap 178 is provided, for example, around the body of the cylinder assembly 10, for the pendant cord 174 (see FIG. 8).

The pendant 162 (shown in FIG. 1) also includes a user input device (e.g., one or more buttons 154′, keys, a touch screen, etc.) configured to receive one or more inputs (e.g., a selection, a command, etc.) from a user. The inputs to the pendant 162 are communicated to the controller 138 to execute selected cylinder assembly functions and/or operations.

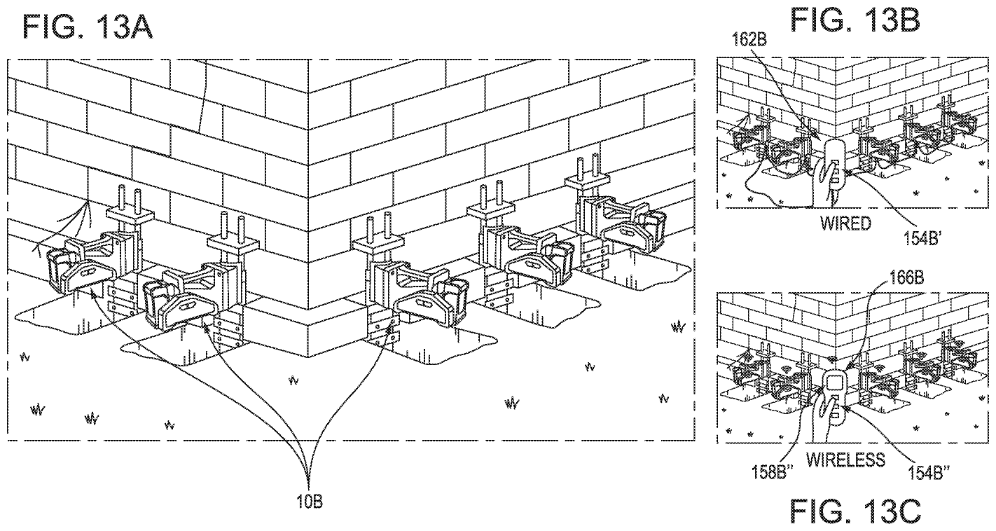

The pendant 162 may include a user feedback or output device (e.g., a display 156′ (see FIG. 13C)) configured to display conditions or data associated with the cylinder assembly 10. The controller 138 communicates with and controls the output to the user (e.g., the condition(s) presented on the display). For example, the display 156′ may be configured to display, in real-time or substantially real-time, a fluid pressure, the position of the piston 106 relative to the cylinder 102 (stroke length), the load, the speed, the capacity of the battery pack 30, etc.

The display 156′ includes, for example, a liquid crystal display (“LCD”), a light-emitting diode (“LED”) display, an organic LED (“OLED”) display, an electroluminescent display (“ELD”), a surface-conduction electronemitter display (“SED”), a field emission display (“FED”), a thin-film transistor (“TFT”) LCD, etc. Alternatively or additionally, the output device may provide other types of output—audible, tactile, etc.

Additionally or alternatively to the CAN bus 170, a port (not shown; e.g., universal serial bus (USB), Ethernet, serial advanced technology attachment (SATA), integrated drive electronics (IDE), etc.) may be provided for connection, communication (e.g., data recording, transfer, etc.) and/or power supply (e.g., to charge the battery 30, to power electronic components of the cylinder assembly 10, etc.).

In other constructions (see, e.g., FIG. 13C), the communication components include at least a wireless transceiver (not shown) configured to transmit and receive signals wirelessly with one or more external devices (e.g., a wireless control device 166) using for example, Wi-Fi, Bluetooth, cellular networks, telematic networks, etc. The transceiver communicates with (e.g., receives signals from and transmits signals to) the controller 138. For example, the controller 138 outputs signals representative of measured values (e.g., position, pressure, tilt, movement, etc.) from the sensor(s) to the transceiver for communication externally from the cylinder assembly 10 (e.g., to the wireless control device 166).

In other constructions (not shown), alternatively or additionally to the cord wrap 178, onboard storage (e.g., a receptacle, a pouch, netting, etc.) may be provided on the cylinder assembly 10, for example, to store the control device 158, the pendant 162 and its cord 174, other accessories, etc. The onboard storage may be separate from and connectable to the cylinder assembly 10 (e.g., to the housing 18). The onboard storage may be removable to separately transport the stored items.

The cylinder assembly 10 may also include one or more onboard illumination devices (not shown) operable to illuminate an area of the cylinder assembly 10 (e.g., the working area). The illumination device(s) may be controlled by the integrated user interface device 150 and/or the external control device 158.

To use the cylinder assembly 10, a battery pack 30 with sufficient capacity and voltage is connected to the compartment interface 90. The cylinder assembly 10 is positioned relative to the load (see, e.g., FIGS. 8-10). Any necessary or desired set up operation may be performed directly on the cylinder assembly 10 with the user interface device 150 and/or the external control device 158 (e.g., calibration of the cylinder assembly 10, advance of the piston 106 to contact the load, etc.). With the cylinder assembly 10 prepared for operation, the user controls the cylinder assembly 10 with the control device 158 to complete the associated operation (e.g., a lifting operation).

FIG. 8 illustrates a lifting operation using a number of cylinder assemblies 10 (two shown), each incorporated with a lift stand 182. A cylinder assembly 10 is incorporated into and provides the lifting mechanism for each lift stand 182 for example, to lift and/or hold at a height a piece of heavy equipment (e.g., for maintenance, repair, etc.). The cylinder assemblies 10 can be set up and/or controlled individually or as a system by a wired pendant 162 (as shown in a daisy chain configuration) or wirelessly by a wireless controller (not shown).

The lift stand 182 includes a locking mechanism (not shown in detail in FIG. 9) to maintain the lifted position of a load in the absence of hydraulic lifting force. The locking mechanism may be locked and unlocked remotely with the pendant 162 and/or with the wireless control device.

FIGS. 9-10 illustrate another lifting operation using a cylinder assembly 10 configured as a toe jack 186. The cylinder assembly 10 is attached to the toe jack 186, and, with the toe jack 186 placed under an object (e.g., a piece of machinery), the cylinder assembly 10 is set up and/or controlled by a wired pendant 162 or by a wireless controller (not shown).

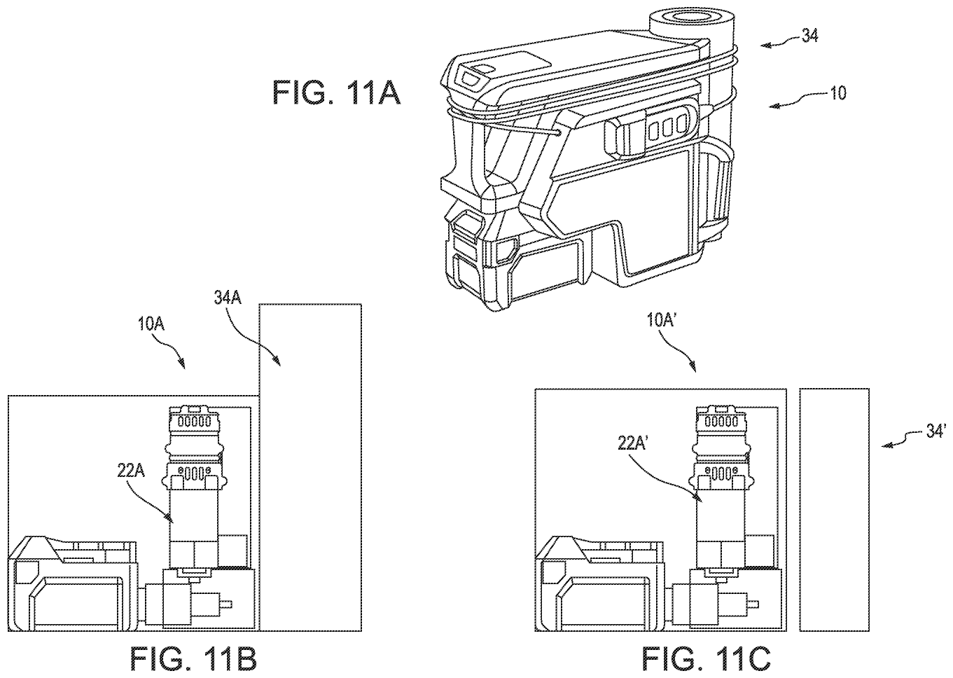

FIGS. 11A-11C illustrate alternative constructions of a cylinder assembly 10, 10A, 10A′. The cylinder assembly 10A, 10A is similar to the cylinder assembly 10, and many of the features will not be discussed in detail again below. Common elements have the same reference number “A” or “A′”.

The cylinder assembly 10A, 10A′ has substantially the same components as the cylinder assembly 10. Unlike the cylinder assembly 10, 10A, the piston-cylinder unit 34A′ does not extend above the housing 18A′, making the entire cylinder assembly 10A′ substantially one height. The cylinder assemblies 10, 10A, 10A′ provide a platform of cylinder assemblies of different tonnages, sizes (e.g., with a piston-cylinder unit stroke length of, for example, 2 in. (not shown), 6 in., 8 in., 10 in.). The capacity of the reservoir 74, 74A, 74A′ may be different based on the size of the associated piston-cylinder unit 34, 34A, 34A′.

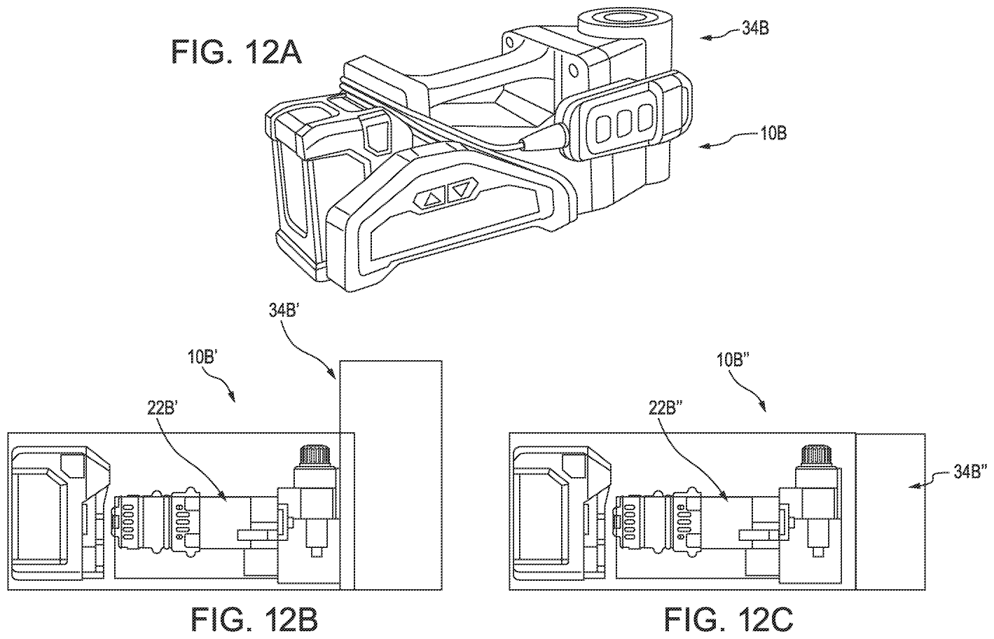

FIGS. 12A-12C illustrates additional alternative constructions of a cylinder assembly 10B, 10B′, 10B″. The cylinder assembly 10B, 10B′, 10B″ is similar to the cylinder assembly 10, 10A, 10A′, and many of the features will not be discussed in detail again below. Common elements have the same reference number “B”, “B′” or “B″”.

Each cylinder assembly 10B, 10B′, 10B″ has the same elements as the cylinder assembly 10, 10A, 10A′. Unlike the cylinder assembly 10, 10A, 10A′, the power unit (i.e., the pump 22B, the motor 26B, the battery pack 30B, etc.) are arranged in a horizontal manner providing a cylinder assembly 10B with a shorter housing. As illustrated, the cylinder assembly 10B has a weight of about 25 lbs. to about 30 lbs. within a package size having a length from the front of the housing 18B to the piston axis P of about 13 in. to about 17 in. (about 14 in., as shown), a housing height of about 5 in. to about 7 in. (6.5 in., as shown) and a housing width of about 5 in.

Unlike the cylinder assembly 10B, 10B′, the piston-cylinder unit 34B″ does not extend above the housing 18B″ making the entire cylinder assembly 10B″ substantially one height. The cylinder assemblies 10B, 10B′, 10B″ provide another platform of cylinder assemblies of different tonnages, sizes smaller than the platform of cylinder assemblies 10, 10A, 10A′ (e.g., with a piston-cylinder unit stroke length of 2 in., 4 in., 6 in.). With the shorter stroke length, the pump 22B, 22B′, 22B″ may be a single stage pump while the pump 22, 22A, 22A′ may be a dual stage pump.

FIG. 13 illustrates a number of cylinder assemblies 10B incorporated into a lifting system and positioned relative to a load, for example, a large object (e.g., a house) for simultaneously lifting, a building foundation for leveling, etc. Once positioned, setup operation(s) may be performed on the cylinder assembly 10B with the user interface device 150B, with a wireless controller 166B or with a wired pendant 162B. For operation, the cylinder assemblies 10B may be controlled individually and as a system wirelessly by the wireless control device 166B or wired (e.g., in a daisy chain) and controlled by the pendant 162B.

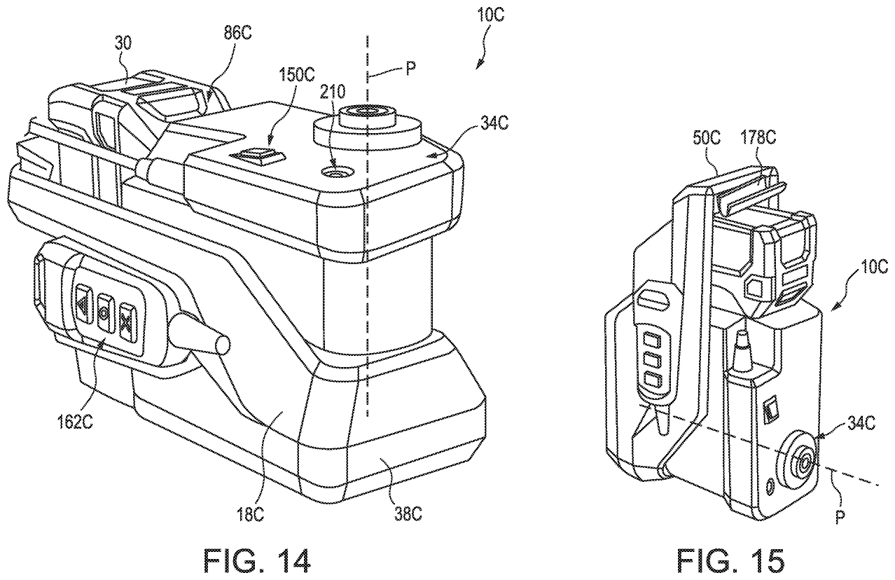

FIGS. 14-18 illustrate another alternative construction of a cylinder assembly 10C. The cylinder assembly 10C is similar to the cylinder assembly 10, 10A, 10B described above and shown in FIGS. 1-13, and common elements have the same reference number “C”. Many of the common features of the cylinder assembly 10C are not described in detail.

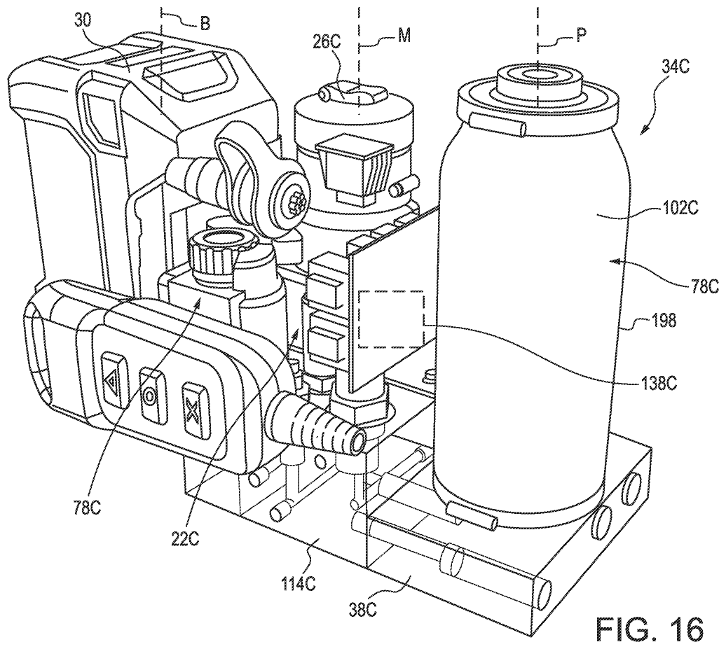

In this construction, the cylinder assembly 10C is self-contained, powered by an integrated, onboard power unit. As shown in FIGS. 14-15, the cylinder assembly 10C may be used in an upright orientation with the piston axis P oriented generally vertically or in an orientation with the piston axis P oriented generally horizontally.

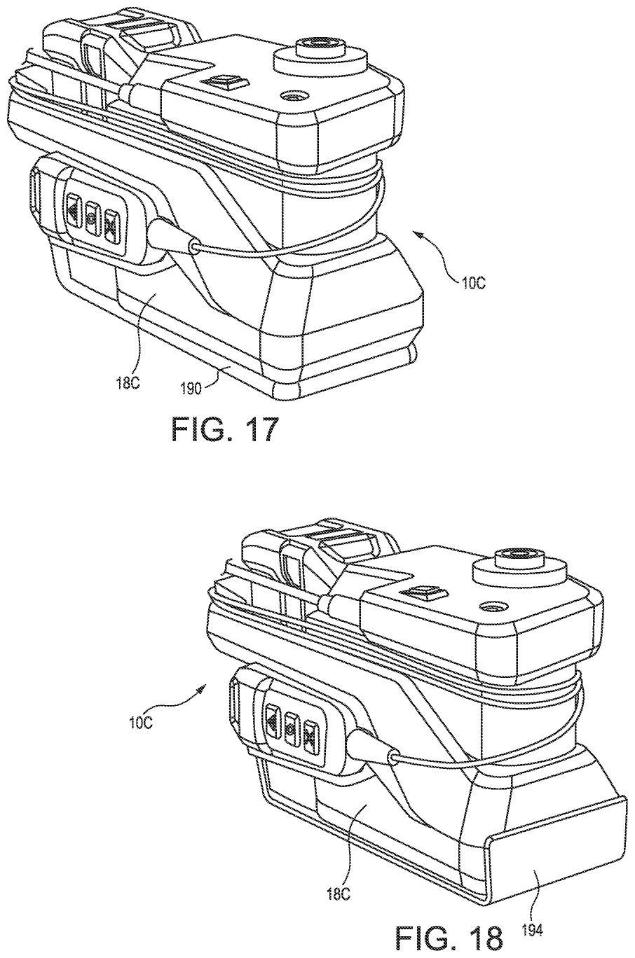

The base plate 38C supports the pump 22C, the motor 26C and the piston-cylinder unit 34C. A skid member (for example, a skid bar 190 (FIG. 17), a skid plate 194 (FIG. 18)) may be connected to the base plate 38C to, for example, facilitate movement of, protect the cylinder assembly 10C.

As shown in FIG. 16, the valve block 114C is formed with the base plate 38C and is sized to fit the piston-cylinder unit 34C. The pump mechanism 58C is secured in the valve block 114C. The pump 22C and the motor 26C are supported on the valve block 114C and, therethrough, on the power unit support portion of the base plate 38C.

The illustrated piston-cylinder unit 34C has a lifting capacity of about 10 T with a piston stroke of about 4 in. The piston-cylinder unit 34C is similar to a bottle jack and includes a self-contained reservoir 74C defined between the outer wall of the cylinder 102C and an external wall 198. The piston-cylinder unit 34C may incorporate a flexible bladder (not shown) in the space between the external wall 198 and the outer wall of the cylinder 102C.

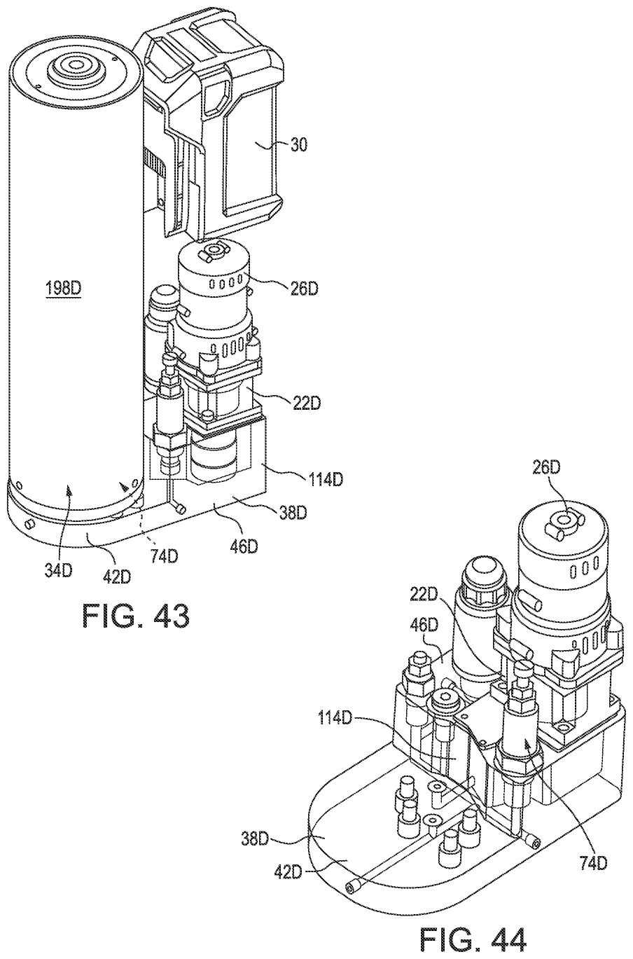

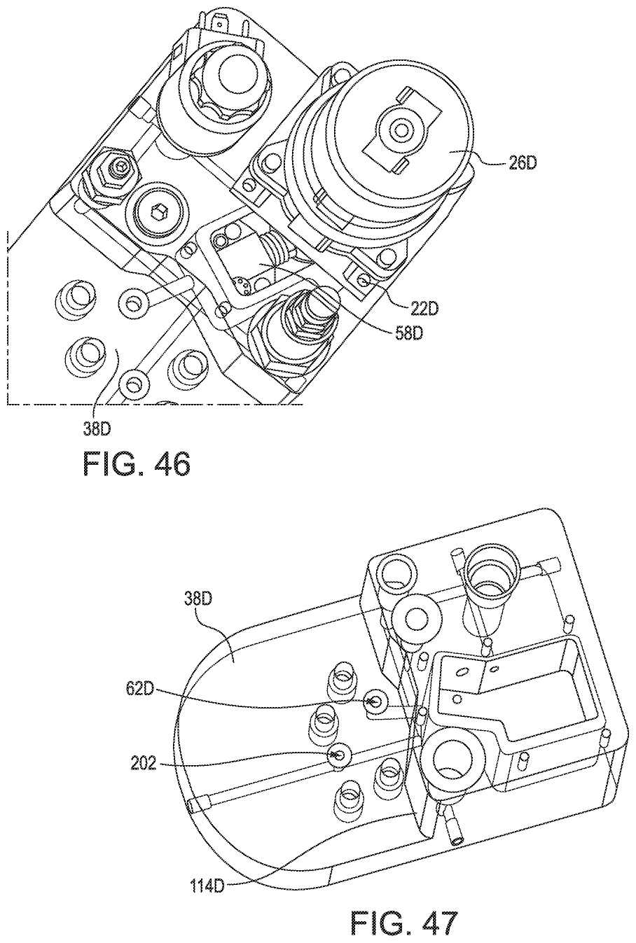

As described below and as shown in FIGS. 43-49, the base of the cylinder 102C defines the cylinder port 110C in fluid communication with a pressure port 202 (see FIG. 47) and a tank port 206 in fluid communication between the reservoir 74C and pump inlet 62C.

As shown in FIG. 14, the battery compartment 86C may extend past the base plate 38C and be suspended. The battery pack 30 is slid vertically into and out of the compartment 86C, for easy insertion and removal. The battery pack 30 is only partially received in the battery compartment 86C to allow for access to the battery pack 30. As shown in FIG. 16, the battery axis B, the piston axis P, and the power unit axis M are all substantially parallel. The piston axis P and the battery axis B lie in a plane, with the power unit axis M being offset from the plane.

One or more onboard illumination devices 210 (one shown; for example, located on top of the housing 18C) operable to illuminate an area of the cylinder assembly 10C (e.g., the working area). More specifically, the illumination device 210 may direct light in a direction parallel to the piston axis P toward the underside of the load (e.g., the area of engagement of the piston 106 with the load). In other construction (not shown), the illumination device 210 may direct light in a different direction (e.g., generally perpendicular to the piston axis P) and/or be adjustable to change the direction of illumination.

The illumination device 210 may include an LED device. The illumination device 210 is powered by the power source (e.g., the battery pack 30). The illumination device 210 may be controlled by the user interface device 150C and/or the external control device 158C (e.g., the pendant 162C).

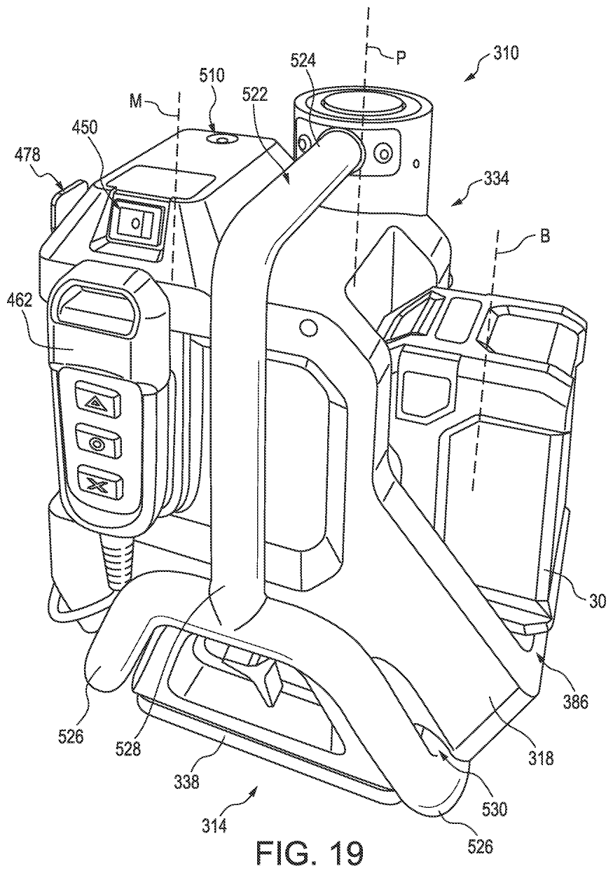

FIGS. 19-24 illustrated another alternative construction of a cylinder assembly 310. The cylinder assembly 300 is similar to the cylinder assembly 10, 10A, 10B, 10C described above and shown in FIGS. 1-18, and common elements have the same reference number plus “300”. Many of the common features of the cylinder assembly 310 are not described in detail.

The cylinder assembly 10 generally includes (see FIGS. 19-23) a frame 314; a housing 318 connected to the frame 314; an onboard power unit with a pump 322, a motor 326, and a power source (e.g., a battery pack 30); and a piston-cylinder unit 334. In the illustrated construction, the piston-cylinder unit 334 has a lifting capacity of about 20 t with a piston stroke of about 8 in.

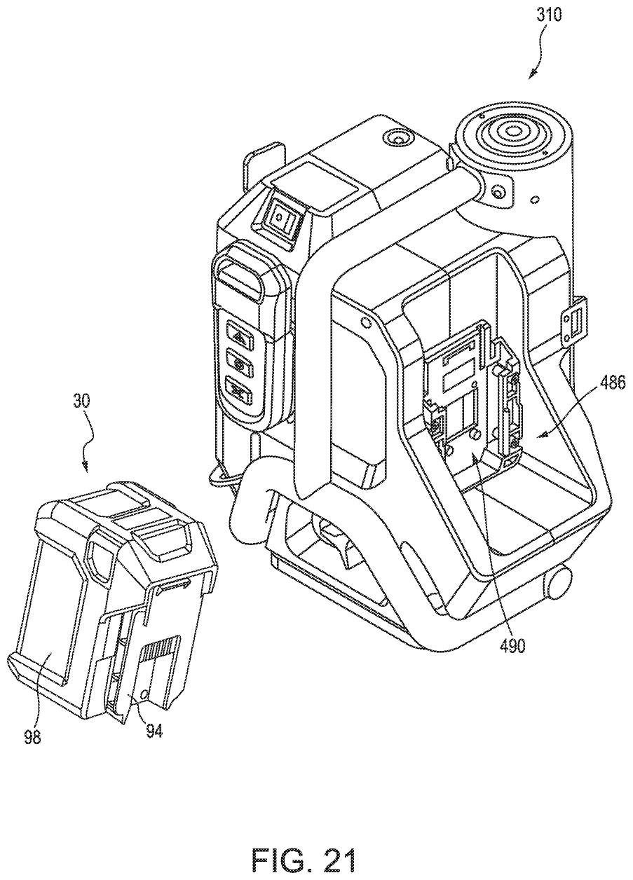

As shown in FIG. 21, the housing 318 defines a battery compartment 386 into which the battery pack 30 is received. As shown, the battery compartment 386 is located on one side of the piston-cylinder unit 334 and extends past the frame 314. The battery compartment 386 allows for the battery pack 30 to be vertically slid into the compartment 386, for easy insertion/removal. The battery pack 30 is only partially received in the battery compartment 386 to allow for access.

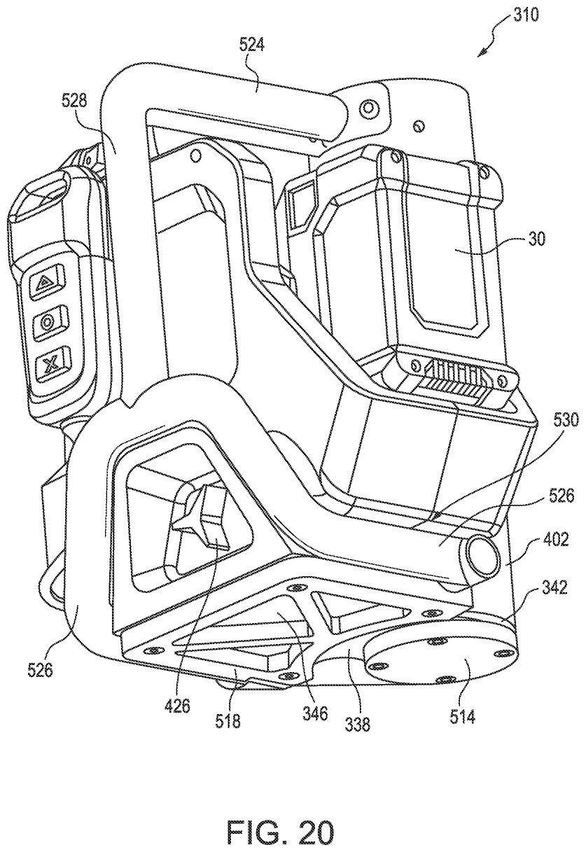

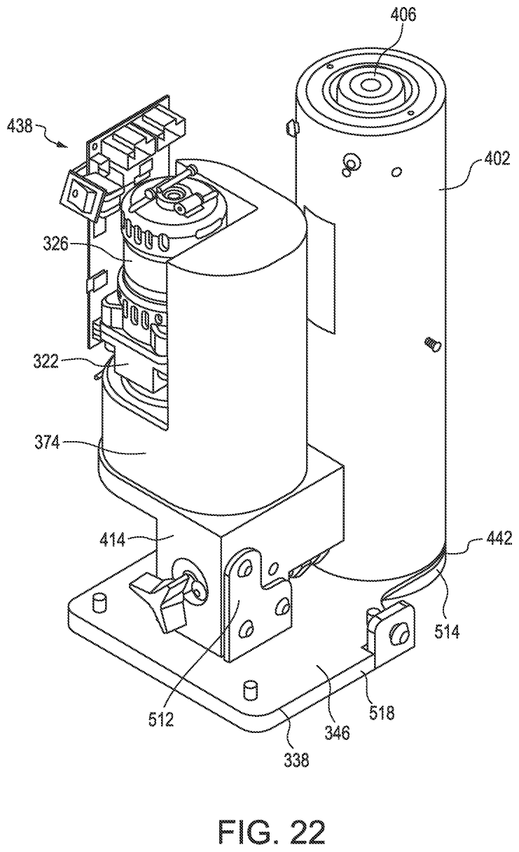

As shown in FIGS. 20 and 22-23, the frame 314 generally includes a base plate 338 having a round cylinder portion 342 tapering to a rectangular power unit portion 346. The closed end of the cylinder 402 and the valve block 414 are connected to respective portions 342, 346 of the base plate 338, for example, by fasteners. As shown in FIG. 22, one or more brackets 512 (one shown) are connected between the base plate 338 and the valve block 414 to, for example, provide additional support to the valve block 414 and supported components (e.g., the pump 322, the motor 326, and the reservoir 374). As described below, in other constructions (see, e.g., FIGS. 27A-27C), the base plate 338 may be removably coupled to the cylinder 302. A subplate 514, 518 is connected to the bottom surface of each base plate portion 342, 346 and may provide additional support to the base plate 338. The illustrated subplate 518 has a webbed construction.

The subplate(s) 514, 518 may be constructed to provide other features. For example, the subplate 514 may facilitate positioning of the cylinder assembly 310 under a load L and may be constructed to reduce friction during positioning (e.g., be formed of or coated with lower coefficient of friction material (compared to other components (e.g., the base plate 338), have tapering edges, etc.). As another example, the subplate 518 may inhibit movement of the cylinder assembly 310 when positioned and may be constructed to increase friction when in position (e.g., be formed of or coated with higher coefficient of friction material (compared to other components (e.g., the base plate 338), have rough surfaces, etc.).

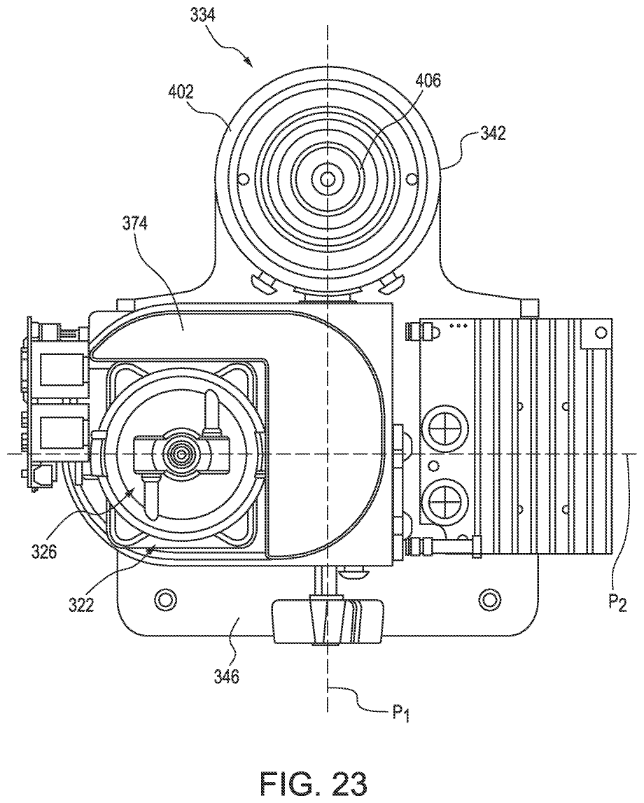

In the illustrated embodiment (see FIG. 23), the piston-cylinder unit 334 bisects the cylinder assembly 310 into a first side, with the pump 322 and motor 326, and a second side, with the battery pack 30. The components of the first and second sides are constructed to have similar weights for stability and balance of the cylinder assembly 310, to inhibit tipping, etc.

As illustrated (see FIGS. 19 and 23), the piston axis P, the power unit axis M, and the battery axis B are all substantially parallel. The piston axis P lies in a first plane P₁ with the battery pack 30 on one side and the motor 326 and the pump 322 on the other side of the first plane P₁. The power unit axis M and the battery axis B lie in a second plane P₂, and, as illustrated, the first plane P₁, containing the piston axis P, is substantially perpendicular to the second plane P₂, containing the power unit axis M and the battery axis B. As shown in FIG. 23, the first plane P₁ intersects the reservoir 374.

As shown in FIGS. 19-21, a roll cage 522 (e.g., a protective bar) is connected to and extends around portions of the housing 318 and may, for example, protect components of the cylinder assembly 310 from damage (e.g., in the case of an impact). In the illustrated construction, the roll cage 522 is connected near the upper end of the piston-cylinder unit 334. The roll cage 522 extends above a portion of the housing 318 and over components of the cylinder assembly 310 (e.g., the pump 322, the motor 326, the reservoir 374, the valve assembly 378, etc.) thereby partially protecting the components.

As illustrated, the roll cage 522 includes an upper bar 524, two lower bars 526 (e.g., legs) and a connecting bar 528. The upper bar 524 is connected to (e.g., by fasteners) and extends from the piston-cylinder unit 334 substantially perpendicular to the piston axis P and in the first plane P₁. The upper bar 524 extends beyond the housing 318 on the side opposite the piston-cylinder 334. The connecting bar 528 is substantially parallel to the piston axis P and is connected to (e.g., merges with) the outer end of the upper bar 524. The connecting bar 528 extends partially down the housing 318 before connecting with the lower bars 526.

The lower bars 526 connect with the connecting bar 528, split and extend generally diagonally down the remainder of the housing 318 to the base plate 338. One lower bar 526 extends under the battery compartment 386 and connects (e.g., by a fastener) to one side of the base plate 338 (relative to the first plane P₁). The other lower bar 526 extends under the power unit portion and connects (e.g., by a fastener) to the other side of the base plate 338 (on the other side of the first plane P₁).

The roll cage 522 is connected to the piston-cylinder unit 334 and the frame 314 (at the base plate 338). The fasteners connecting the roll cage 522 to the frame 314 extend from the outside through the housing 318 to the frame 314. Because the roll cage 522 is connected from the outside, the roll cage 522 can be removed for access to internal components in the housing 318, during operation of the cylinder assembly 310, etc. The housing 318 has cutout portions or recesses 530 in which the lower bars 526 of the roll cage 522 lie (see FIG. 20).

Portions of the roll cage 522 provide points to lift the cylinder assembly 310. For example, the upper bar 524 of the roll cage 522 can be engageable by a user to lift the cylinder assembly 310, for example, for transport to, from and around a work site. Because the upper bar 524 extends in the first plane P₁ bisecting the cylinder assembly 310 into generally balanced first and second sides, the user may be able to carry the cylinder assembly 310 more easily.

Portions of the roll cage 522 (e.g., the upper bar 524, the connecting bar 528, etc.) may provide a lift point for hoisting the cylinder assembly 310. Portions of the roll cage 522 (e.g., the lower bar(s) 526) may provide an anchor point for holding the cylinder assembly 310.

The illustrated cylinder assembly 310 includes (see FIG. 19) an integrated user interface device 450 positioned on the housing 318. In the illustrated construction, the integrated user interface device 450 only allows the user to power on and off the cylinder assembly 310. The cylinder assembly 310 may be further controlled by a remote device (e.g., a pendant 462), as described above. A cord wrap 478 (partially shown in FIG. 19) is on a side of the housing 318. The housing 318 defines a receptacle 542 sized to receive and retain the pendant 462.

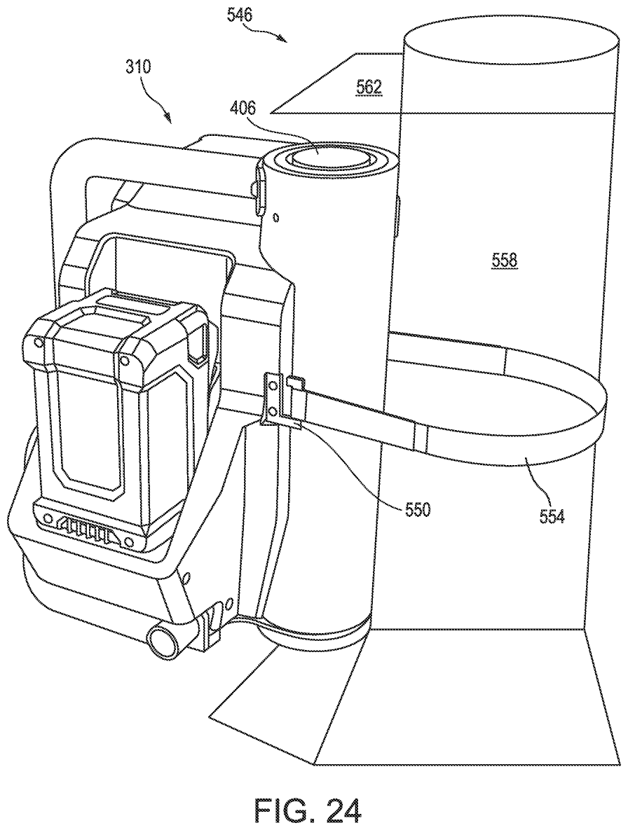

In the illustrated construction (see FIG. 24), an attachment mechanism is configured to mount the cylinder assembly 310 to a jack stand 546 (schematically illustrated). The attachment mechanism may include a pair of connectors 550 (one shown) with a webbing belt 554 (e.g., a strap). The connectors 550 are secured to opposite sides of the housing 318. One connector 550 (shown in FIG. 24) includes an open, hooked end to releasably receive one end of the belt 554, while the other connector 550 (not shown) is closed and secures the other end of the belt 554. In this construction, the cylinder assembly 310 mounts to the jack stand 546 by wrapping the belt 554 around the jack stand 546 and then attaching the belt 554 to the hooked end of the connector 550a. The belt 554 can be tightened with a ladder lock (not shown) to further secure the cylinder assembly 310 to the jack stand 546. Once positioned, the belt 554 holds the cylinder assembly 310 in position on the jack stand 546 and keeps the cylinder assembly 310 from falling out (at least during setup).

In another construction (not shown), the attachment mechanism may include an integrated tether with rigid loops connected to opposite sides of the housing 318 and a cord, a cable, a rope, etc., connected to the loops and extending around a portion of the jack stand 546.

The cylinder assembly 310 may be used supported on a ground surface to lift a load as described above with the cylinder assembly 10. To use the cylinder assembly 310 with a jack stand 546 to lift a load, a battery pack 30 with sufficient capacity and voltage is connected to the compartment interface 390. The cylinder assembly 310 is secured to the jack stand 546 by connecting the housing 318 of the cylinder assembly 310 to the frame 558 of the jack stand 546 and connecting the piston 406 to the load support 562 of the jack stand 546. Thereafter, the piston 406 and the load support 562 are engaged with the load (not shown). Any necessary or desired set up operation may be performed on the cylinder assembly 310 (e.g., calibration of the cylinder assembly 310, advance of the piston 406 to contact the load, etc.).

With the cylinder assembly 310 prepared for operation, the user controls the cylinder assembly 310 with the remote control device 458 (e.g., the pendant 462) to complete the associated operation (e.g., a lifting operation). The motor 326 is powered and drives the pump 322 to supply hydraulic fluid to move the piston 406 from a retracted position to an advanced position. Movement of the piston 406 causes the load support 562 to move and lift the load.

Once the operation is completed (e.g., the load is lifted), the load support 562 is locked (e.g., held) in the lifted position by a locking mechanism (not shown; e.g., a locking pin). Thereafter, the cylinder assembly 310 is disconnected from the jack stand 546. The piston 106 is retracted out of engagement with the load support 562 (e.g., to the retracted position). The housing 318 of the cylinder assembly 310 is disconnected from the jack stand frame 558.

When the load is to be adjusted (e.g., lowered), if the cylinder assembly 310 was removed, it is reattached as described above. The cylinder assembly 310 is engaged with the load support 562 with the piston 106 being extended to support the load. The locking mechanism is disengaged, and the cylinder assembly 310 is operated to move the load. To lower the load, hydraulic fluid is released from the cylinder 402, and the piston 406 retracts along with the load support 562 and the supported load. Once operations with the cylinder assembly 310 are completed, the cylinder assembly 310 can be removed from the jack stand 546 for use in another operation, storage, etc.

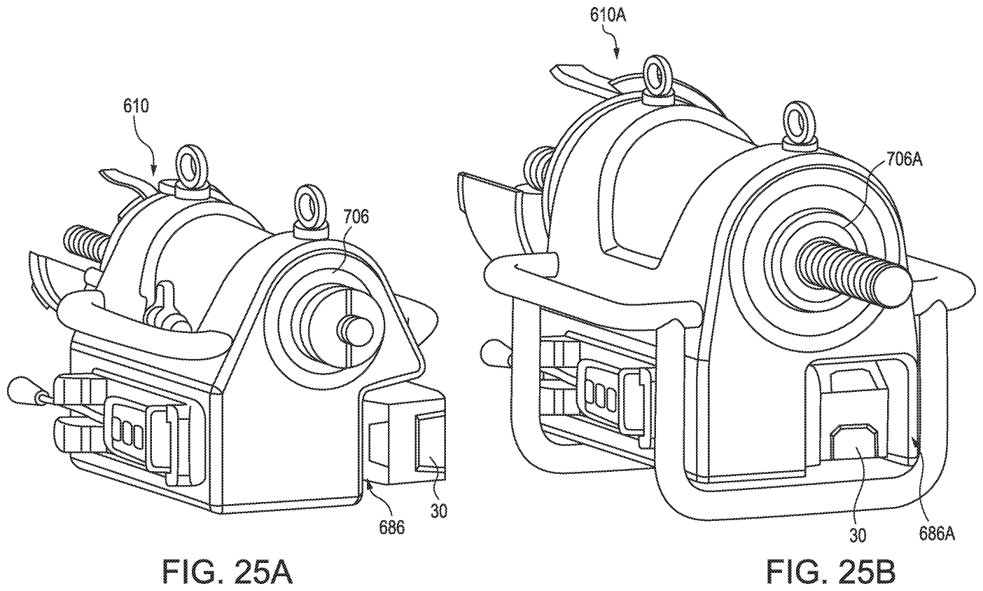

FIGS. 25A-32B illustrate additional alternative constructions of cylinder assemblies 610, 610A. Each cylinder assembly 610, 610A is similar to the cylinder assembly 10, 10A, 10B, 10C, 310 described above and shown in FIGS. 1-24, and common elements have the same reference number plus “600”, “600A”. Many of the common features of the cylinder assembly 610, 610A are not described in detail.

Each cylinder assembly 610, 610A generally includes (see, e.g., FIGS. 25A-25B, 28, and 30) a frame 614, a housing 618, an onboard power unit with a pump 622, a motor 626, and a power source (e.g., a battery pack 30), and a piston-cylinder unit 634 including a piston 706 movably supported by a cylinder 702.

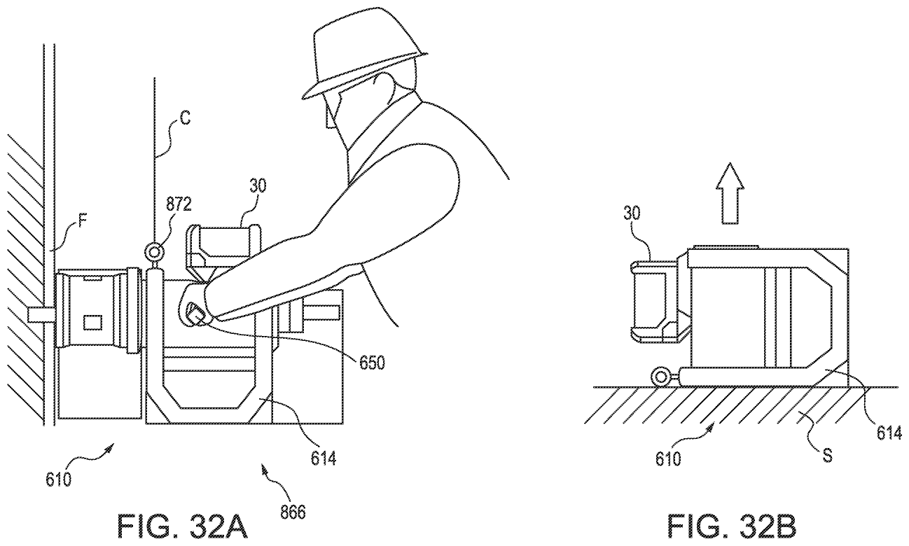

The illustrated cylinder assemblies 610, 610A (see FIG. 32A) may be included in a pin pulling system 866 operable to pull a pin (not shown) from a machine frame F. The system 866 also includes a pull rod 868, received through the hollow piston 706, a reaction member 870, to connect the pull rod 868 to the piston 706, and a support member (e.g., a column member 638′), positionable between the cylinder assembly 610 and the work surface S of the frame F.

At least one lifting eye or rigging point 872 (two shown) is provided at an upper side of the cylinder assembly 610. In use with the pin pulling system 866, the rigging point 872 may be connected to a rope, cable, chain C or other support to support the cylinder assembly 610 above the ground. One or more handles 650 (two shown) are provided on frame 614 and/or the housing 618 for an operator to, for example, hold, support, control, etc. the cylinder assembly 610. In the illustrated construction, the battery pack 30 is supported on the upper side of the cylinder assembly 610 with the power unit supported below the piston-cylinder unit 634.

With reference to FIG. 32B, the cylinder assembly 610 may also be used as a lifting or jacking device. In this configuration, the cylinder assembly 610 includes a base plate 638 positionable on the ground or on another work surface S in an orientation of a typical cylinder. As shown in FIG. 32A, the cylinder assembly 610 is configured with limited and/or removable components (e.g., a removable pull rod 868, a column member 638′, etc.) at its ends (e.g., in “no fly zones) to not impede use of the cylinder assembly 610 on the ground as shown in FIG. 32B.

As shown in FIGS. 25A-25B, the cylinder assembly 610, 610A may be constructed to provide different tonnage/load capacities, stroke length, etc. The cylinder assembly 610 shown in FIG. 25A may provide a tonnage capacity of about 30 t while the cylinder assembly 610A shown in FIG. 25B may provide a tonnage capacity of about 60 t. The components of each cylinder assembly 610, 610A are constructed to provide the required characteristics and may be optimized (e.g., capacity, size, etc.) for use with the piston-cylinder unit 634, 634A and/or to the requirements of the cylinder assembly 610, 610A.

FIGS. 25A and 26-29 illustrate the cylinder assembly 610 with the pin pulling system 866 in more detail. As shown in FIG. 25A, the housing 618 defines a battery receptacle or compartment 686 located on one side of the piston-cylinder unit 634 into which the battery pack 30 is received. The battery compartment 686 allows for removal of the battery pack 30 along a battery axis B parallel to the piston axis P and in a direction away from the support member (e.g., the column member 638′, the base plate 638, etc.).

The illustrated compartment 686 does not enclose the battery pack 30. The bottom of the battery pack 30 extends beyond the housing 618; however, one handle 650 extends over the exposed bottom of the battery pack 30. One side of the battery pack 30 is covered by the housing 618 (e.g., the upper side in FIG. 25A) while the opposite side is not covered by the housing 618. In other constructions (see, e.g., FIGS. 25B), the battery compartment 686A may more fully enclose the battery pack 30. In the illustrated construction, the battery pack 30 is within the extent defined by the planes of the housing 618 though one side is uncovered (e.g., the lower side in FIG. 25B).

As shown in FIGS. 27A-27C, the support member (e.g., the column member 638′, the base plate 638, etc.) is removably connectable to the end of the cylinder 702 by a connection assembly, for example, for substitution of one type of support member for another (e.g., the column member 638′ for the base plate 638 or vice versa), for replacement or repair, etc. In the illustrated construction, the connection assembly is a toolless connection assembly facilitating installation and removal of the support member relative to the cylinder 702 at least substantially without the use of an additional tool.

The illustrated connection assembly includes a first connection member (e.g., a plate assembly 874) supported proximate the end of the cylinder 702 and a complementary second connection member (e.g., a plate assembly 878) supported on the support member. Each connection plate assembly 874, 878 is connected to the associated structure, for example, by fasteners (as shown). In other constructions (not shown), the plate assembly 874 and/or 878 may be supported in another manner (e.g., welding, adhesive, etc.).

The connection plate assemblies 874, 878 include one or more projections 874a, 878a (four shown) and complementary recesses 874b, 878b (four shown on the plate assembly 874; three shown on the plate assembly 878). Each projection 874a, 878a is received in an associated recess 874b, 878b for initial engagement of the plate assemblies 874, 878. The plate assemblies 874, 878 are then relatively moved (e.g., pivoted) to axially restrain the projection(s) 874a, 878a in a groove 874c, 878c communicating with the recess 874b, 878b. Once pivoted to the connected position, a positive locking member (not shown; e.g., a movable pin, a fastener, etc.) may be installed to inhibit relative movement of the plate assemblies 874, 878 from the connected position toward the released position.

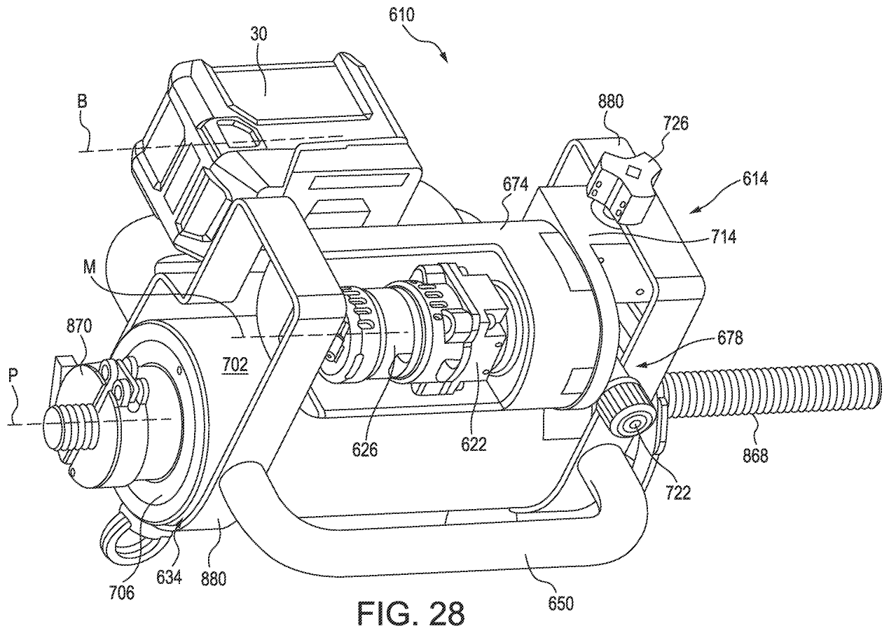

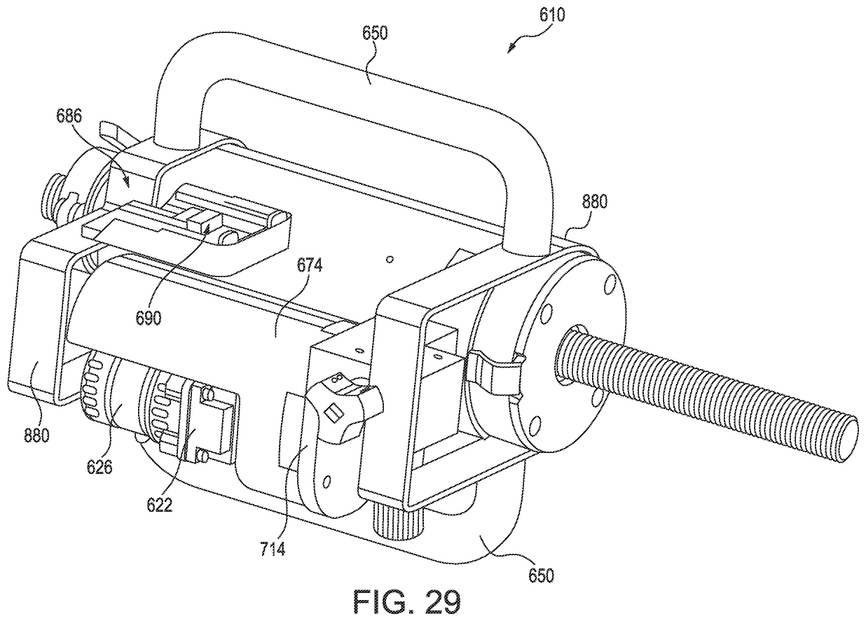

The illustrated piston-cylinder unit 634 is a single-acting unit. In other constructions (not shown), the piston-cylinder unit 634 may be a double-acting unit. As shown in FIGS. 28-29, the illustrated frame 614 includes one or more frame members 880 (two shown) connected to the cylinder 702 and supporting components of the cylinder assembly 610. Each frame member 880 has a curved portion extending around and connected to an outer portion of the cylinder 702, an opposite, flat base portion, and connecting portions extending between the curved portion and the base portion. The flat portions provide a rigid base when supporting the cylinder assembly 610 on a surface (e.g., a ground surface). The connecting portion of one frame member 880 (remote from the support member) defines a notch area fitting the battery compartment 686.

The power unit (e.g., the pump 622 and the motor 626) along with the reservoir 674 and the valve block 714 are connected to and supported on the frame 614 (e.g., on the frame member 280 closer to the support member). More specifically, the valve block 714 is fixed directly to the frame member 880, the pump 622 and the reservoir 674 are fixed to the valve block 714, and the motor 626 is supported on the pump 622. The frame 614 thus supports the weight of the components of the cylinder assembly 610.

Each handle 650 is connected between the two frame members 880 to provide a substantially rigid frame 614. When the cylinder assembly 610 is supported by the handles 650 (e.g., by one or more operators), the frame 614 supports the components of the cylinder assembly 610. Similarly, as shown in FIG. 28, a rigging point 872 is directly connected to each frame member 880. When the cylinder assembly 610 is supported by the rigging points 872 (e.g., on a lifting device), the frame 614 supports the components of the cylinder assembly 610.

As illustrated (see FIGS. 28-29), the piston axis P, the power unit axis M, and the battery axis B are all substantially parallel. The piston axis P lies in a plane with the battery pack 30 on one side and the motor 626 and the pump 622 on the other side of the plane such that the components on each side of the plane are substantially balanced. The rigging point(s) 872 lie on the plane so that, when the cylinder assembly 610 is supported by, for example, a lifting device, the cylinder assembly 610 will be substantially balanced.

The power unit axis M and the battery axis B lie in a second plane P₂, and, as illustrated, the first plane P₁, containing the piston axis P, is substantially perpendicular to the second plane P₂, containing the power unit axis M and the battery axis B. The first plane P₁ intersects the reservoir 674.

As shown in FIG. 27A, two handles 650 are disposed on opposite sides of the housing 618 to provide a T-handle shape. As shown in FIGS. 28-29, the handles 650 are connected to the frame members 880 to act as a roll cage (e.g., a protective bar) around portions of the housing 618 and may, for example, protect components of the cylinder assembly 610 from damage (e.g., in the case of an impact). In the illustrated construction, the handles 650 extend around a portion of the housing 618 and over components of the cylinder assembly 610 (e.g., the pump 622, the motor 626, the reservoir 674, the valve assembly 678, etc.) to protect the components.

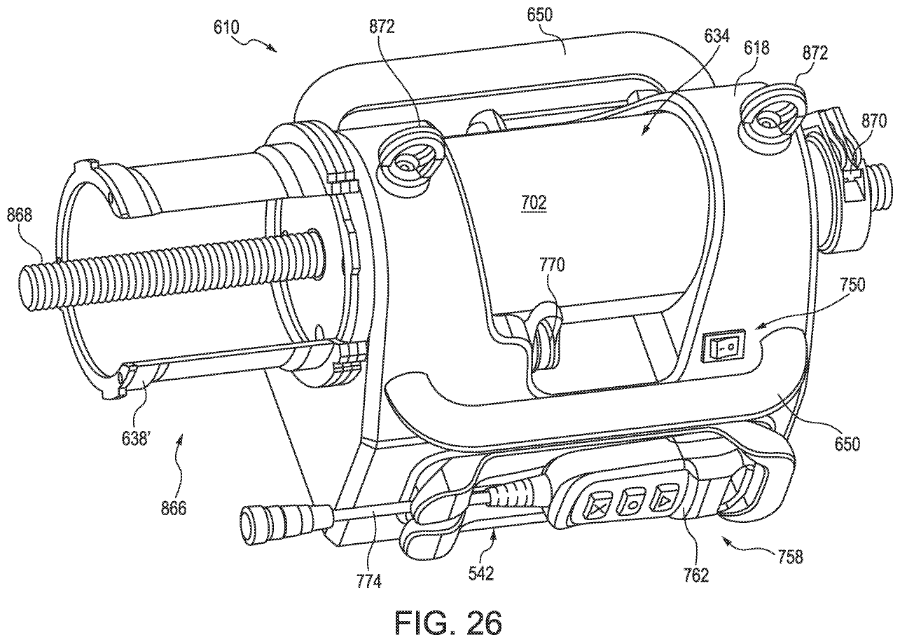

The cylinder assembly 610 includes (see FIG. 26) an integrated user interface device 750 positioned on the housing 618, which, as illustrated, only allows the user to power on and off the cylinder assembly 610. The cylinder assembly 610 may be further controlled by a remote control device 758 (e.g., a pendant 762), as described above. The housing 618 may also include a receptacle 842 sized to receive and retain the pendant 762, such that the pendant 762 can stored with the cylinder assembly 610.

FIGS. 25B and 30-31 illustrate an alternative construction of the cylinder assembly 610A and the pin pulling assembly 866A. In the illustrated construction, the cylinder assembly 610A and the pin pulling assembly 866A have a capacity of about 60 t.

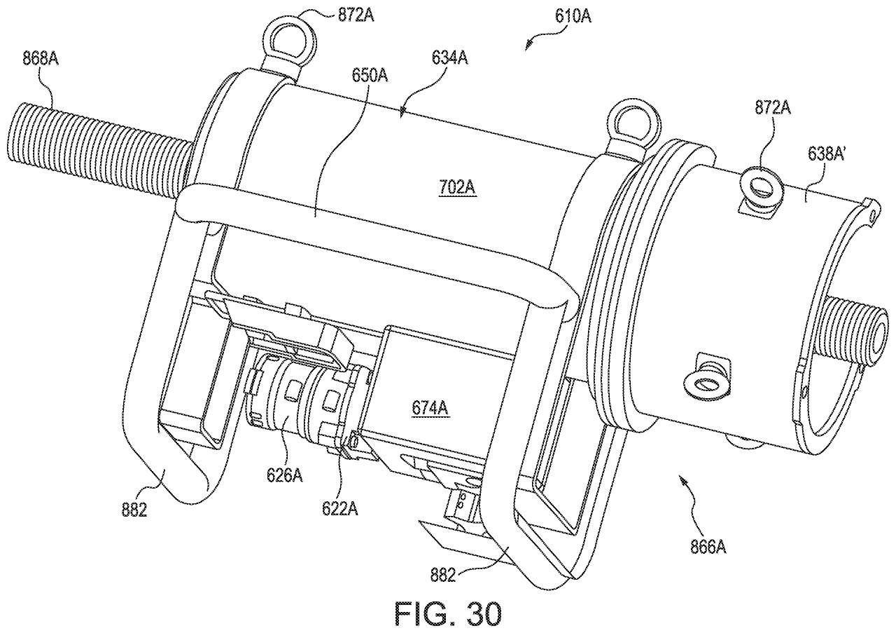

As shown, additional bars 882 are connected to the handles 650A and extend around the housing 618A (e.g., around the lower sides and the bottom of the housing 618A). The handles 650A and the bars 882 act as a roll cage (e.g., a protective bar) around portions of the housing 618A and may, for example, protect components of the cylinder assembly 610A from damage (e.g., in the case of an impact). As shown in FIG. 30, additional lifting eyes 872 are provided on the column member 638A′ for additional support.

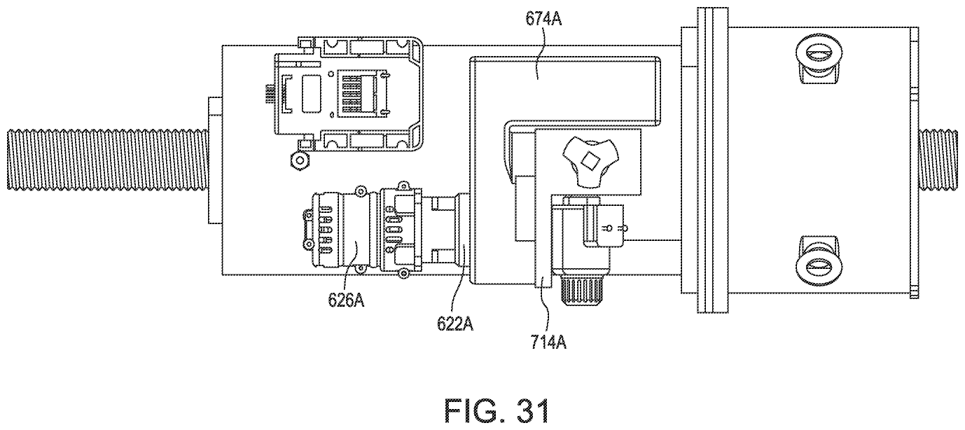

As shown in FIG. 31, rather than extending around the pump 622A and the motor 626A (as in the cylinder assembly 610), in the cylinder assembly 610A, the reservoir 674A extends in the opposite direction and extends around the valve block 714A. The position of the reservoir 674A may better balance the weight of the cylinder assembly 610A.

Use of the cylinder assemblies 610, 610A is similar and will be described with reference to the cylinder assembly 610. An initial step in using the cylinder assembly 610, 610A and the associated pin pulling system 866, 866A is selecting the appropriate pair based on the required load (e.g., for pulling the pin, for lifting an object, etc.).

To use the cylinder assembly 610, a battery pack 30 with sufficient capacity and voltage is connected to the compartment interface 690. The cylinder assembly 610 is positioned for the desired operation. Any necessary or desired set up operation may be performed on the cylinder assembly 610 (e.g., calibration of the cylinder assembly 610, advance of the piston 706 to contact the load, etc.).

For use with the pin pulling system 866, the components are arranged relative to the frame F and the pin to be pulled. One or more column members 638′ (functioning as column sections) are positioned between the piston-cylinder unit 634 and the machine frame F. The first column member 638′ is connected at the cylinder end to the cylinder 702 via the connection assembly, and the frame end is positioned against the machine frame F. As mentioned above, to maintain the components of the system 866 in position, the rigging position(s) 872 may be connected to supporting structure.

The pull rod 868 is inserted through the axial passage of the piston 706 and connected to (e.g., threaded into) the pin to be pulled. The reaction member 870 is supported on the pull rod 268 proximate the end of the piston 706. The reaction member 870 may be threaded along the pull rod 868 into engagement with the end the piston 706 or with the saddle (not shown), if provided. The system 866 is ready to be operated to pull the pin.

The user controls the cylinder assembly 610, for example, with the remote control device 758 (e.g., the pendant 762) to complete the associated operation (e.g., a pin pulling stroke). The motor 626 is powered and drives the pump 622 to supply hydraulic fluid to the piston-cylinder unit 634. As fluid flows into the cylinder 702, the piston 706 extends axially.

As the piston 706 is extended, the pull rod 868 and pin are moved axially as well. Engagement between the end of the piston 706 and the reaction member 870 causes the reaction member 870 to transfer the force on the piston 706 to the pull rod 868. The column member 638′ bears against and transfers the reaction force between the cylinder 702 and the column member 638′ to the machine frame F.

If the length of the stroke of the piston 706 (e.g., about 2 in. to about 4 in.) is shorter than length of the pin (typically, between about 10 in. to about 20 in.), the system 866 is adjusted to continue the pulling operation. If the length of the assembled column member(s) 638′ (e.g., the length of each column member is about 6.5 in.) is sufficient for another stroke of the piston 706, the system 866 is reset. The reaction member 270 is disengaged from the piston 706, and the piston 706 is retracted. The reaction member 270 is re-engaged with the piston 706, and hydraulic fluid is supplied to extend the piston 706 and pull the pin.

If the length of the assembled column member(s) 638′ is not sufficient for another piston stroke, the system 866 is reset, and another column member 638′ (not shown) is added. The system 866 is then operated to provide a sufficient number strokes of the piston 706 to remove the pin from the machine frame F. Once the pin is removed from the machine frame F, the system 866 remains supported at the rigging point(s) 872. The system 866 may then be removed for storage, transport, etc. or assembled in another location for use in pulling another pin or for another operation (e.g., a lifting operation with the cylinder assembly 610).

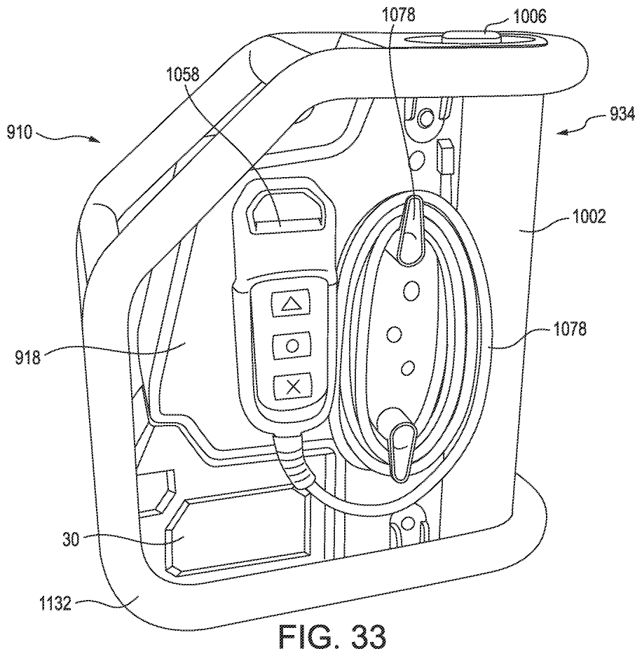

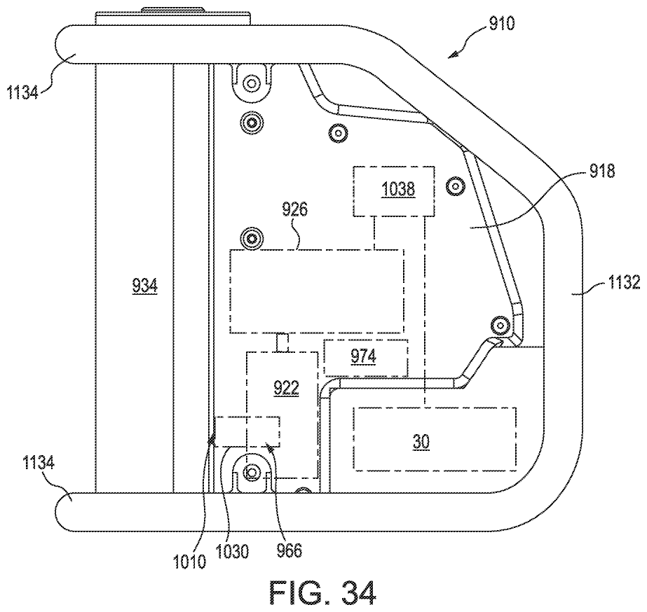

FIGS. 33-38B illustrate an alternative construction of a cylinder assembly 910. The cylinder assembly 910 is similar to the cylinder assembly 10, 10A, 10B, 10C, 310, 610, 610A described above and shown in FIGS. 1-32B, and common elements have the same reference number plus “900”. Many of the common features of the cylinder assembly 910 are not described in detail.

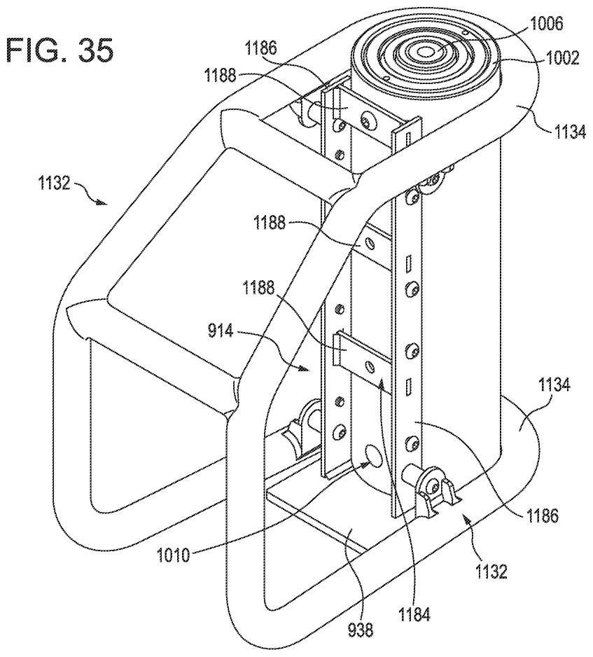

As shown in FIG. 35, the frame 914 generally includes a base plate 938, defining slots and openings, and a frame member 1184. The illustrated frame member 1184 includes spaced apart bars 1186 connected by one or more crossbars 1188 (three shown). For connection, the bars 1186 define slots, and each opposite end of a crossbar 1188 extends into a slot in each bar 1186. As illustrated, the frame member 1184 is connected to the base plate 938 with an end of each bar 1186 extending into an associated slot in the base plate 938.

The frame member 1184 is connected to the sidewall of the cylinder 1002 (by fasteners through openings in the crossbar(s) 1188). In some constructions, the bars 1186 may also be connected along the sidewall of the cylinder 1002. The housing 918 encloses the frame member 1184 and has a curved surface engageable with the sidewall of the cylinder 1002.

As shown in FIGS. 33-35, a roll cage 1122 is connected to and extends around portions of the housing 918 and the piston-cylinder unit 934 and may, for example, protect components of the cylinder assembly 910 from damage (e.g., in the case of an impact). In the illustrated construction, the housing 918, including the battery compartment 986 with a supported battery pack 30, the pump 922, the motor 926, the reservoir 974, the valve assembly 978, etc., are within the roll cage 1122. The illustrated roll cage 1122 has a cage portion 1132 on each side of the housing 918. The cage portions 232 are connected by a connecting portion 1134 and by one or more crossbars 1136 (two shown in FIG. 35).

As illustrated, each cage portion 1132 has an upper bar and a lower bar, and the connecting portion 1134 has an upper connecting bar and a lower connecting bar. The crossbar(s) 1136 connect the upper bars of the cage portions 1132. In FIG. 35, the connecting portion 1134 extends around the piston-cylinder unit 934 so that at least a substantial portion of the piston-cylinder unit 934 is within the extent of the roll cage 1122. In other constructions (not shown), the connecting portion 1134 may extend around the housing 918.

The roll cage 1122 is connected to the housing 918 and to the frame 914. As shown in FIG. 35, one cage portion 1132 is connected to the bar 1186 on one side, and the other cage portion 1132 is connected to the bar 1186 on the other side. As shown in FIGS. 33 and 35, the fasteners connecting the roll cage 522 to the frame 914 extend from the outside through the housing 918 to the frame 14. Because the roll cage 1122 is connected from the outside, the roll cage 1122 can be removed for access to internal components in the housing 918, during use, etc.

The roll cage 1122 is rigidly connected to the pump 922, the motor 926, and the piston-cylinder unit 934 through the frame 914. The frame member 1184 is generally along a center of gravity of the cylinder assembly 910.

Portions of the roll cage 1122 provide points to lift the cylinder assembly 910. For example, the upper bars of the cage portions 1132 and the crossbar(s) 1136 are engageable by a user to lift the cylinder assembly 910, for example, for transport to, from and around a work site. These portions of the roll cage 1122 may be used as lifting anchors for hoisting the cylinder assembly 910.

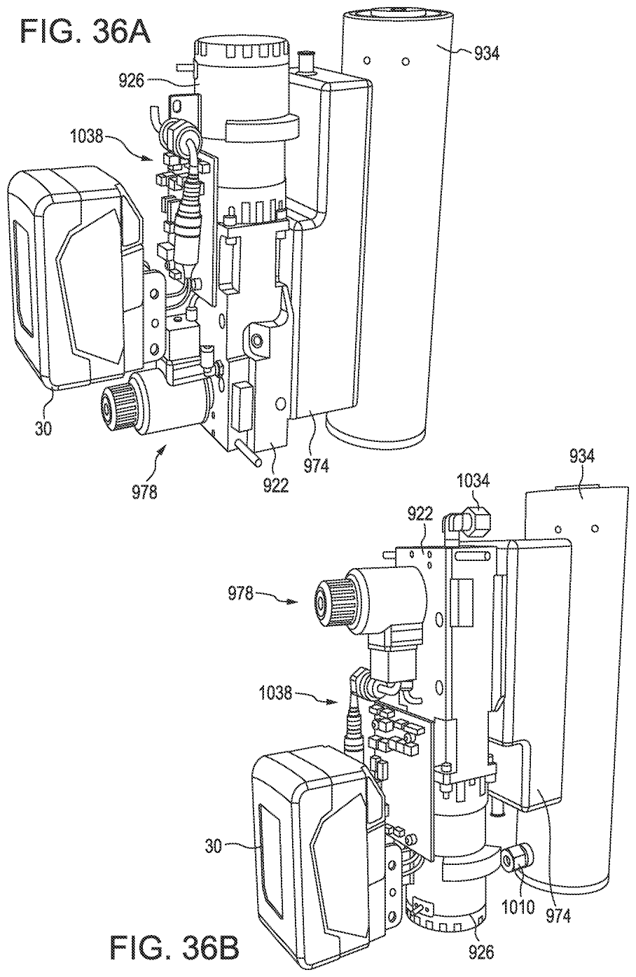

FIGS. 36A-36B illustrate potential arrangements of internal components of the cylinder assembly 910. As shown in FIG. 36A, in one construction, the motor 926 is positioned above and supported on the pump 922. In the alternative construction of FIG. 36B, the pump 922 is positioned above and supported on the motor 926. In each illustrated construction, the reservoir 974 is positioned between the power unit (the pump 922 and the motor 926) and the piston-cylinder unit 934. A conduit (not shown) connects (see FIG. 36B) the valve block port 1034 to the cylinder port 1010. The valve assembly 978 controls the flow of hydraulic fluid relative to the cylinder port 1010.

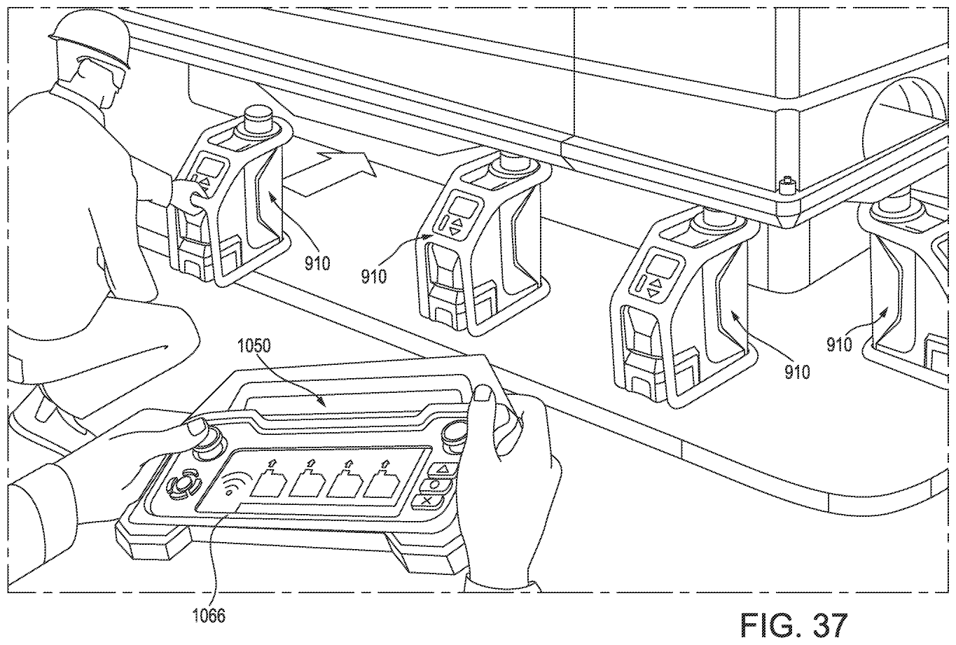

The illustrated cylinder assembly 910 includes (see FIG. 37) an integrated user interface device 1050 positioned on the housing 918 and located within the extent of the roll cage 1122. The interface device 1050 includes a user input device (e.g., one or more buttons 1054, keys, a touch screen, etc.) configured to receive one or more inputs (e.g., a selection, a command, etc.) from a user. The inputs are communicated to the controller 1038 to execute selected cylinder assembly functions and/or operations. For example, the user input device may include a power button, a “pair” button for use in wirelessly connecting the cylinder assembly 910 to an external device, a “select” button, etc. The user input device may also provide integrated controls for the piston-cylinder unit 934 (e.g., an “advance” button to advance the piston 1006, a “retract” button to retract the piston 1006, etc.).

The interface device 1050 also includes a user feedback or output device (e.g., a display 1056) configured to communicate, display, etc. conditions or data associated with the cylinder assembly 910. The controller 1038 communicates with and controls the output to the user (e.g., the condition(s) presented on the display 1056 (see FIG. 37)). For example, the display 1056 may be configured to display, in real-time or substantially real-time, a fluid pressure, position of the piston 1006 relative to the cylinder 1002 (stroke length), load, speed, capacity of the battery pack 30, etc. The display 1056 includes, for example, a liquid crystal display (“LCD”), a light-emitting diode (“LED”) display, an organic LED (“OLED”) display, an electroluminescent display (“ELD”), a surface-conduction electronemitter display (“SED”), a field emission display (“FED”), a thin-film transistor (“TFT”) LCD, etc. Alternatively or additionally, the output device may provide other types of output—audible, tactile, etc.

FIG. 37 illustrates a number of cylinder assemblies 910 included in a lifting system and positioned relative to a load, for example, a large object (e.g., a house) for simultaneous lifting, a building foundation for leveling, etc. Once positioned, setup operation(s) may be performed directly on the cylinder assembly 910 with the user interface device 1050, with a wireless controller 1066 (as shown) or with a wired pendant 1062. For operation, the cylinder assemblies 910 may be controlled individually and as a system wirelessly by the wireless control device 1066 (as shown) or wired (e.g., in a daisy chain) and controlled by the pendant 1062.

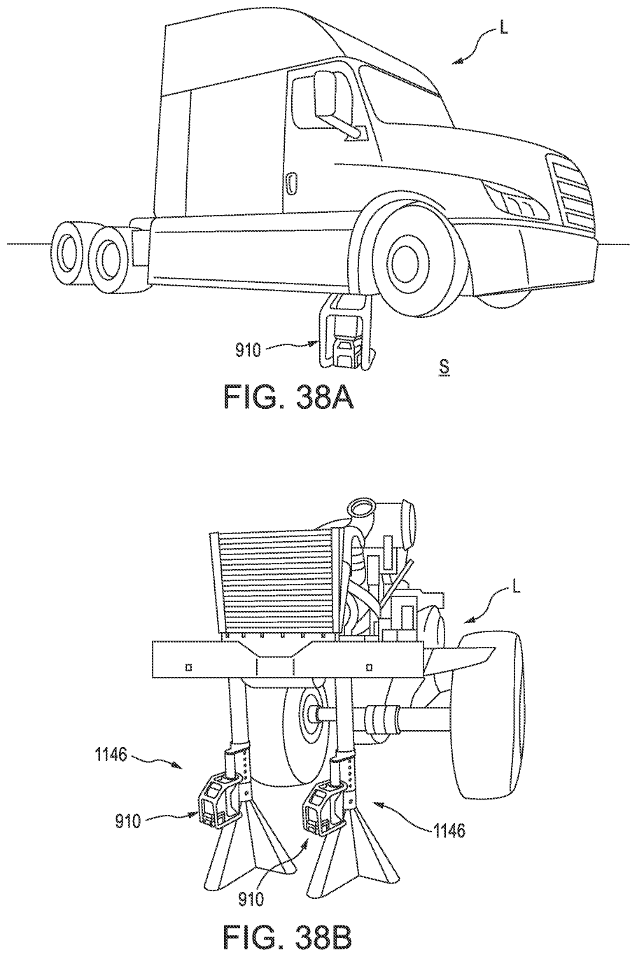

FIGS. 38A-38B illustrate one or more cylinder assemblies 910 in different lifting operations. In FIG. 38A, the cylinder assembly 910 is positioned on a ground surface and used as a lifting or jacking device. In FIG. 38B, a cylinder assembly 910 is supported on a jack stand 1146, and a pair of cylinder assemblies 910 and jack stands 1146 are used to lift a load.

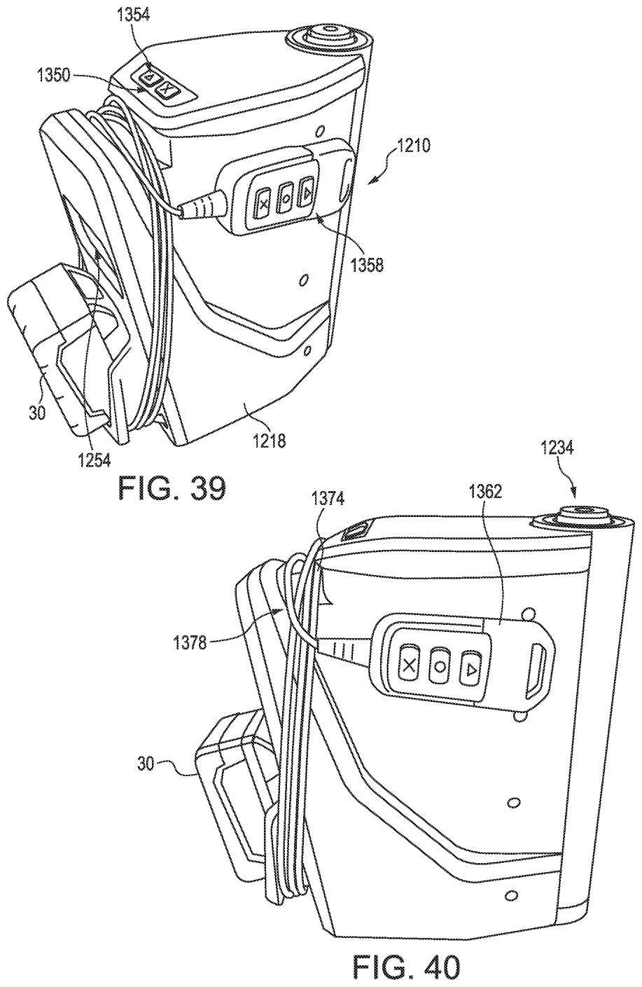

FIGS. 39-42 illustrate another alternative construction of a cylinder assembly 1210. The cylinder assembly 1210 is similar to the cylinder assembly 10, 10A, 10B, 10C, 310, 610, 610A, 910 described above and shown in FIGS. 1-38B, and common elements have the same reference number plus “1200”. Many of the common features of the cylinder assembly 1210 are not described in detail.

In this construction (see, e.g., FIGS. 39-40), the cylinder assembly 1210 generally includes a frame 1214, a housing 1218, an onboard power unit with a pump 1222, a motor 1226, and a power source (e.g., a battery pack 30), and a piston-cylinder unit 1234. The illustrated cylinder assembly 1210 is self-contained, powered by an integrated, onboard power unit and weighs about 36 pounds (lbs.).

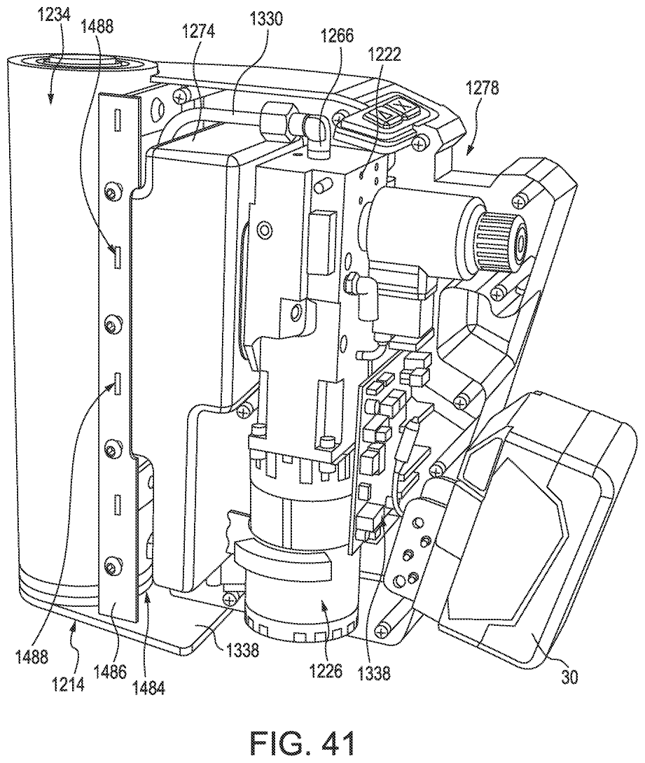

As shown in FIG. 41, the frame 1214 generally includes a base plate 1238 and a frame member 1484. The illustrated frame member 1484 includes spaced apart bars 1486 connected by one or more crossbars 1488 (three partially shown). As illustrated, the frame member 1484 is connected to the base plate 1238.

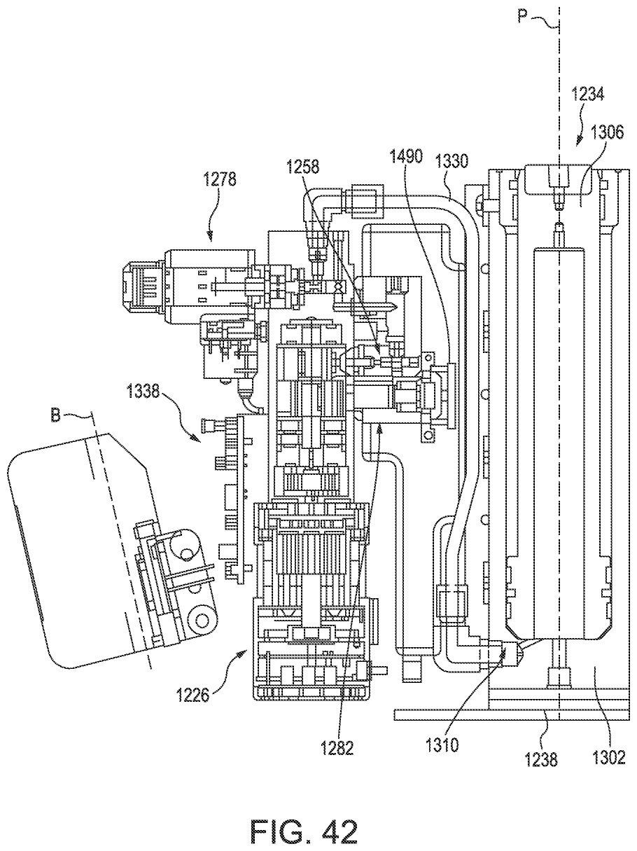

The internal components of the cylinder assembly 1210 are shown in more detail in FIGS. 41-42. The pump 1222 and the motor 1226 are supported on the frame 1214 (e.g., by the reservoir 1274) and positioned within the housing 1218. A conduit 1330 fluidly connects the pump 1222 and the piston-cylinder unit 1234.

The reservoir 1274 defines (see FIG. 42) an opening 1282 through its front face. The pump mechanism 1258 extends through the opening 1282 into the reservoir 1274 and is sealed in the opening 1282 to inhibit leaking. An inlet protector 1490 connected to the pump mechanism 1258 filters out sediment, other particles, etc., which could damage the pump 1222, and inhibits excess the hydraulic fluid from entering the pump mechanism 1258.

As shown in FIG. 42, the battery pack 30 is installed and removed from the compartment 1286 along a battery insertion axis B arranged at an angle relative to the piston axis P. The upper portion of the housing 1218 overhangs the compartment interface 1290. The axes B, P lie in a plane, and the plane intersects the pump 1222, the motor 1226, the piston-cylinder unit 1234, the battery pack 30, and the reservoir 1274.

As shown in FIG. 39, the housing 1218 defines a recessed grip portion 1254 engageable by a user to lift the cylinder assembly 1210, for example, for transport to, from and around a work site. An integrated user interface device 1350 is positioned on the housing 1218. The interface device 1350 includes a user input device (e.g., one or more buttons 1354, keys, a touch screen, etc.) configured to receive one or more inputs (e.g., a selection, a command, etc.).

FIGS. 43-49 illustrate alternative constructions of components of a cylinder assembly, such as the cylinder assembly 10C. The components are similar to those described above, and many of the features will not be discussed in detail again below. Common elements have the same reference number “D”.

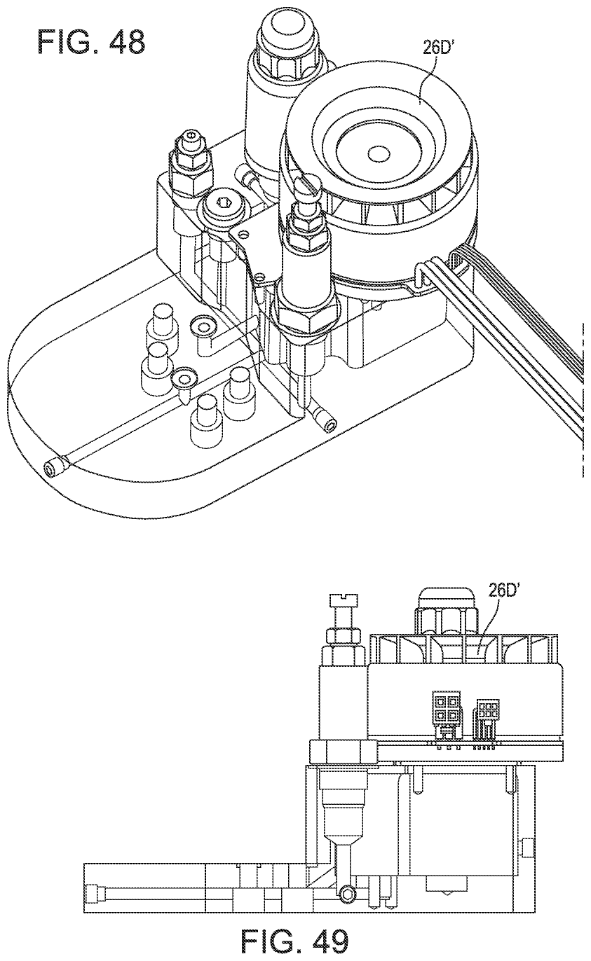

In this construction, the illustrated base plate 38D has a round cylinder portion 42D and a rectangular power unit portion 46D. The closed end of the cylinder 102D is connected to the cylinder portion 42D, and the pump 22D and the motor 26D are secured to the power unit portion 46D. In FIGS. 43-44, the motor 26D is a brushed electric motor. In FIGS. 48-49, the motor 26D′ is a direct brushless motor that does not need a reductor for a shorter-bodied design.

As shown in FIG. 47, a valve block 114D is formed with the base plate 38D, and this component may be common to any size of piston-cylinder unit 34D in a platform of cylinder assemblies 10D. The pump mechanism 58D is secured in the valve block 114D. A plurality of passages and ports are formed within the base plate 38D and the valve block 114D, and a solenoid valve control system 118D is attached to valve block 114D and is operable to control the flow of hydraulic fluid between the piston-cylinder unit 34D and the pump 22D.

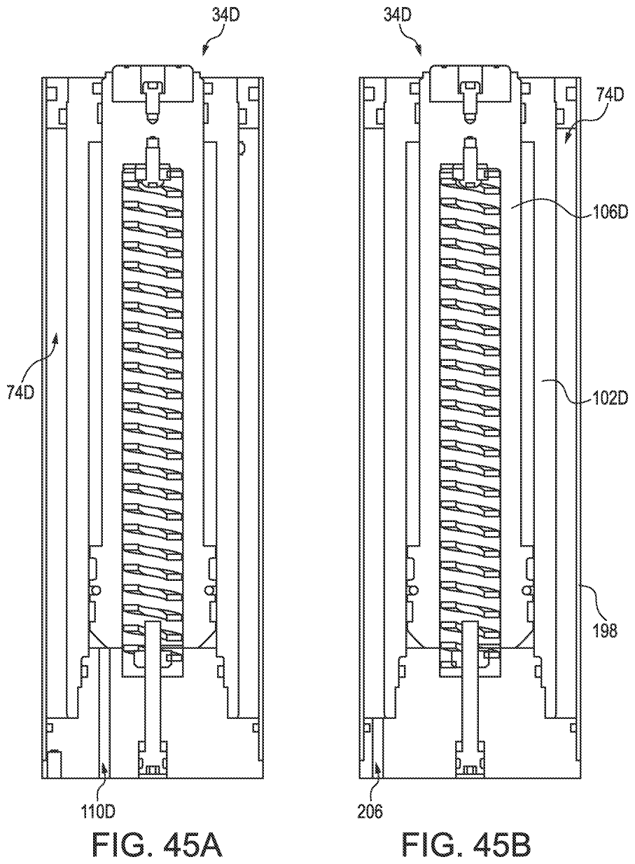

Turning to FIGS. 45A-45B, for some aspects and as illustrated, the piston-cylinder unit 34D is similar to a bottle jack and includes a self-contained reservoir 74D defined between the outer wall of the cylinder 102D and an external wall 198. The piston-cylinder unit 34D may incorporate a flexible bladder (not shown) in the space between the external wall 198 and the outer wall of the cylinder 102D. As shown in FIG. 45A, the base of the cylinder 102D defines the cylinder port 110D in fluid communication with a pressure port 202 (see FIG. 47) and, as shown in FIG. 45B, a tank port 206 in fluid communication between the reservoir 74D and an inlet port 62D (see FIG. 47) of the pump 22D.

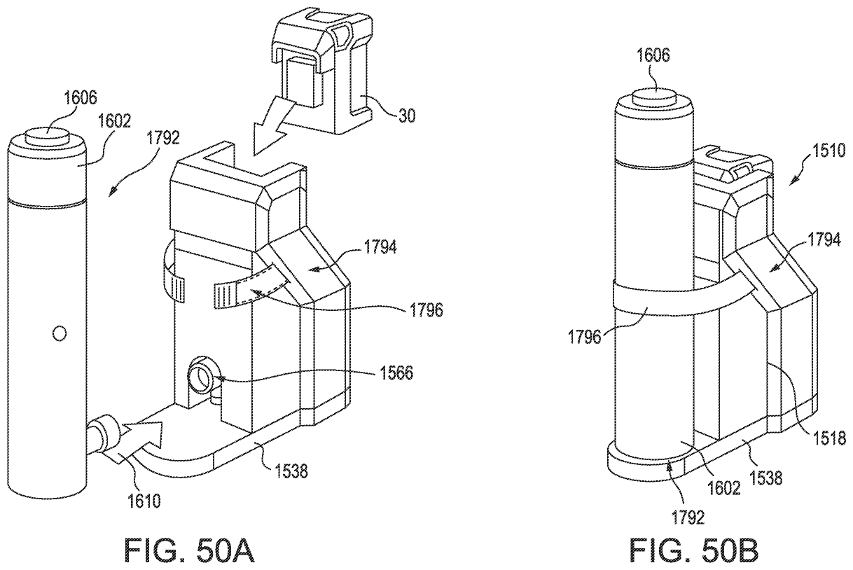

FIGS. 50A-50B illustrate an alternative construction of a cylinder assembly 1510. The cylinder assembly 1510 is similar to the cylinder assembly 10, 10A, 10B, 10C, 310, 610, 910, 1210, 1510, and many of the features will not be discussed in detail again below. Common elements have the same reference number plus “1500”.

The illustrated cylinder assembly 1510 generally includes a separate piston-cylinder unit 1792 selectively connectable to a power unit 1794 by a releasable connector 1796 (e.g., a quick-connect strap). The piston-cylinder unit 1792 includes a cylinder 1602 supporting a piston 1606 and having a port 1610 connectable to the pump port 1562. The power unit 1794 generally includes, supported within a housing 1518, a pump (not shown) with a port 1562, a motor (not shown), and a power source (e.g., a battery pack 30). The piston-cylinder unit 1792 is supportable on the base plate 1538, and the connector 1796 retains the units 1792, 1794.

In the illustrated construction, the power unit 1794 is connectable to a range (e.g., operating pressure, cylinder capacity, stroke length, dimensions, etc.) of different piston-cylinder units 1792 and may be optimized to that range. In other constructions (not shown), the power unit 1794 may be usable with a single type of piston-cylinder unit 1792 (e.g., with a specific operating pressure, cylinder capacity, stroke length, dimensions, etc.) or with substantially any type of piston-cylinder unit 1792 (with little to no limitation on operating pressure, cylinder capacity, stroke length, dimensions, etc.).

Use of the cylinder assembly 1510 is similar to that of the cylinder assembly 10. As an initial step, a suitable or desired piston-cylinder unit 1792 and compatible power unit 1794 are selected for a given operation (e.g., a lifting operation). The ports 1610, 1562 are fluidly connected, and the connector 1796 is engaged to connect the units 1792, 1794. The cylinder assembly 1510 is then positioned and operated as described above.

As discussed above and shown in the figures, a battery-powered, self-contained hydraulic cylinder assembly 10, 10A, 10B, 10C, 310, 610, 910, 1210 may integrate the pump and power source (an electric motor powered by a battery pack) directly with the piston-cylinder unit. As a result, in contrast to operation of conventional piston-cylinder units, the user does not need a separate pump, hoses, and/or electrical cords. The onboard power unit allows an operator to conveniently transport the cylinder assembly 10, 10A, 10B, 10C, 310, 610, 910, 1210 to/from and around a work area and to operate the cylinder assembly 10, 10A, 10B, 10C, 310, 610, 910, 1210 in work area with limited access to electrical power and/or pneumatics.

In an alternative construction, a separate power and pump unit 1794 may be quickly attached to a piston-cylinder unit 1792 through a coupling and attachment mechanism 1796. This may allow existing piston-cylinder units 1792 to be converted to a battery-powered, self-contained hydraulic cylinder assembly 1510.

The illustrated battery-powered, self-contained hydraulic cylinder assembly 10, 10A, 10B, 10C, 310, 610, 910, 1210, 1510 may be used in many hydraulic cylinder applications such as, for example, heavy equipment lifting and jacking, toe jacks for machine lifting and moving, bridge maintenance, foundation repair, building moving, rail jacking and stressing, pin and bearing pulling or pushing, tensioning, synchronous lifting, etc.

Table 1 below illustrates characteristics and parameters of exemplary cylinder assemblies 10, 10A, 10B, 10C, 310, 610, 910, 1210, 1510 with a given maximum rated capacity and piston stroke length and having an aluminum cylinder.

TABLE 1

| Maximum rated | Stroke | Weight | No. of |
|---|---|---|---|
| capacity (t) | length (in.) | range (lbs.) | cycles |
| 15 | 2 | 25-30 | 43-52 |
| 15 | 4 | 26-32 | 21-26 |
| 15 | 6 | 27-33 | 14-17 |
| 20 | 2 | 28-35 | 32-39 |
| 20 | 4 | 29-36 | 16-19 |
| 20 | 6 | 31-38 | 10-13 |
| 20 | 8 | 32-39 | 8-10 |
| 20 | 10 | 33-41 | 6-8 |
| 30 | 2 | 30-37 | 21-26 |
| 30 | 4 | 32-39 | 10-13 |
| 30 | 6 | 34-41 | 7-9 |
| 30 | 8 | 36-44 | 5-6 |
| 50 | 2 | 41-51 | 12-15 |
| 50 | 4 | 45-55 | 6-8 |
| 100 | 2 | 60-73 | 6-8 |

Table 2 below illustrates characteristics and parameters of exemplary cylinder assemblies 10, 10A, 10B, 10C, 310, 610, 910, 1210, 1510 with a given maximum rated capacity and piston stroke length and having an aluminum cylinder and a hollow piston.

TABLE 2

| Maximum rated | Stroke | Weight | No. of |
|---|---|---|---|
| capacity (t) | length (in.) | range (lbs.) | cycles |
| 20 | 2 | 32-38 | 32-39 |
| 20 | 4 | 33-41 | 16-19 |
| 20 | 6 | 36-44 | 10-13 |
| 20 | 8 | 38-46 | 8-10 |
| 20 | 10 | 40-49 | 6-8 |
| 30 | 2 | 37-45 | 21-26 |
| 30 | 4 | 41-50 | 10-13 |
| 30 | 6 | 44-54 | 7-9 |
| 30 | 8 | 48-59 | 5-6 |
| 60 | 2 | 54-66 | 10-13 |
| 60 | 4 | 61-75 | 5-6 |
| 100 | 2 | 89-109 | 7-9 |

In Tables 1-2, the number is cycles is with a single, fully-charged battery pack 30 at 80% of maximum rated capacity of the cylinder assembly 10.

It should be understood that one or more features of one construction of a cylinder assembly 10, 10A, 10B, 10C, 310, 610, 910, 1210, 1510, described above or illustrated in the drawings may be incorporated into another construction.

One or more independent features and/or independent advantages of the invention may be set forth in the claims.

1. (canceled)

2. (canceled)

3. (canceled)

4. A cylinder assembly comprising:
a housing;
a hydraulic pump supported within the housing;
a motor supported within the housing and operable to power the pump;
a power source supported by the housing and operable to supply power to the motor;
a cylinder coupled to the housing and having a first end and an opposite second end;
a piston movably supported by the cylinder, the pump being operable to supply hydraulic fluid to the cylinder to move the piston relative to the cylinder through the second end at least from a retracted position to an advanced position;
a support member engageable with a work surface to support the cylinder assembly relative to the work surface, the support member being coupled to the cylinder; and
a valve block supported in the housing and defining a passage selectively in fluid communication between the pump and the cylinder, the pump being connected to and supported on the valve block.

5. A cylinder assembly comprising:
a power unit including
a housing,
a hydraulic pump supported within the housing,
a motor supported within the housing and operable to power the pump,
a power source supported by the housing and operable to power to the motor;
a piston-cylinder unit including
a cylinder having a first end and an opposite second end, and
a piston movably supported by the cylinder, hydraulic fluid being suppliable to the cylinder to move the piston through the second end at least from a retracted position to an advanced position; and
a coupling mechanism including
a support member couplable to the power unit and to the piston-cylinder unit, the support member being engageable with a work surface to support the power unit and the piston-cylinder unit relative to the work surface,
a hydraulic coupling fluidly connectable between the pump and the cylinder, when connected, the pump being operable to supply hydraulic fluid to the cylinder to move the piston through the second end, and
a connector connectable between the housing and the cylinder.

6. A cylinder assembly comprising:
a housing;
a hydraulic pump supported within the housing;
a motor supported within the housing and operable to power the pump;
a power source supported by the housing and operable to supply power to the motor;
a cylinder coupled to the housing and having a first end provided by an end wall and an opposite, second end, an inlet opening being defined through the end wall;
a piston movably supported by the cylinder and cooperating with the cylinder to define a chamber, hydraulic fluid being suppliable through the inlet opening to the chamber to move the piston through the second end at least from a retracted position to an advanced position;
a support member engageable with a work surface to support the cylinder assembly relative to the work surface; and
a manifold having a body defining a passage in fluid communication with the pump and a port communicating with the passage; the first end of the cylinder directly engaging the manifold to fluidly connect the inlet opening and the port thereby placing the passage and the chamber in fluid communication.

7. The cylinder assembly of claim 4, wherein the first end of the cylinder is provided by an end wall, an inlet opening being defined through the end wall, wherein the piston and the cylinder cooperate to define a chamber, the pump supplying hydraulic fluid through the inlet opening to the chamber to move the piston through the second end and wherein the cylinder assembly further comprises a manifold having a body defining a passage in fluid communication with the pump and a port communicating with the passage, the first end of the cylinder directly engaging the manifold to fluidly connect the inlet opening and the port thereby placing the passage and the chamber in fluid communication.

8. The cylinder assembly of claim 6, wherein the manifold is formed as a part of the support member.

9. The cylinder assembly of claim 6, wherein the port is a first port, wherein the body defines a second port, and wherein the cylinder assembly further comprises a reservoir supported within the housing and configured to contain hydraulic fluid, the reservoir defining a reservoir outlet, the reservoir outlet being in fluid communication with the second port.

10. The cylinder assembly of claim 9, wherein the end wall defines the reservoir outlet.

11. The cylinder assembly of claim 9, wherein the cylinder and the manifold are directly engageable to fluidly connect the reservoir outlet and the second port.

12. The cylinder assembly of claim 9, wherein the cylinder has a side wall extending between the first end and the second end, and wherein the cylinder assembly further comprises a reservoir wall at least partially surrounding the side wall, the reservoir having a volume at least partially defined between the reservoir wall and the side wall.

13. The cylinder assembly of claim 6, further comprising:
a power unit including the housing, the hydraulic pump supported within the housing, the motor supported within the housing, and the power source supported by the housing; and
a piston-cylinder unit including the cylinder, and the piston movably supported by the cylinder; and
a coupling mechanism including
a support member couplable to the power unit and to the piston-cylinder unit, the support member being engageable with a work surface to support the power unit and the piston-cylinder unit relative to the work surface,
a hydraulic coupling fluidly connectable between the pump and the cylinder, when connected, the pump being operable to supply hydraulic fluid to the cylinder to move the piston through the second end, and
a connector connectable between the housing and the cylinder.

14. The cylinder assembly of claim 5, wherein the support member is fixed to the housing, the support member having a cylinder portion engageable with the first end of the cylinder.

15. The cylinder assembly of claim 5, wherein the connector is fixed to the housing and is engageable around the cylinder to connect the power unit and the piston-cylinder unit.

16. The cylinder assembly of one of claim 5, further comprising a valve block supported in the housing and defining a passage selectively in fluid communication between the pump and the cylinder.

17. The cylinder assembly of claim 16, wherein the pump is mounted on the valve block, and wherein the motor is supported on the pump.

18. The cylinder assembly of claim 4, wherein the support member includes a base plate supportable on the work surface to support the cylinder assembly on the work surface, the base plate being connected to the cylinder, wherein the base plate has a cylinder portion and a power unit portion, the first end of the cylinder being connected to the cylinder portion, the valve block being mounted on the power unit portion, the pump and the motor being supported on the valve block.

19. The cylinder assembly of claim 16, further comprising a reservoir configured to contain hydraulic fluid and in fluid communication with the pump, the reservoir being mounted on the valve block.

20. The cylinder assembly of claim 4, wherein the cylinder includes a sidewall extending between the first end and the second end, wherein the cylinder assembly further comprises a frame member connected to the sidewall of the cylinder, the valve block being mounted on the frame member.

21. The cylinder assembly of claim 4, wherein the support member is a first support member having a first support configuration, and wherein the cylinder assembly further comprises:
a second support member selectively couplable with the cylinder, the second support member having a second support configuration different than the first support configuration; and
a coupling assembly configured to selectively couple the cylinder and one of the first support member and the second support member.

22. The cylinder assembly of claim 21, wherein the first support member includes a base plate supportable on the work surface to support the cylinder assembly on the work surface, the base plate being connectable to the cylinder.

23. The cylinder assembly of claim 22, wherein the base plate is a first base plate having a first configuration, wherein the second support member includes a second base plate supportable on the work surface to support the cylinder assembly on the work surface, the second base plate having a different second configuration, and wherein the coupling assembly is configured to selectively couple the cylinder and one of the first base plate and the second base plate.

24. The cylinder assembly of claim 23, wherein the first base plate has a first cylinder portion, the first end of the cylinder being connectable to the first cylinder portion, and wherein the second base plate has a second cylinder portion and a power unit portion, the first end of the cylinder being connectable to the second cylinder portion, the pump and the motor being supportable on the power unit portion.

25. The cylinder assembly of claim 21, wherein the cylinder assembly is configured for use in a pin puller assembly, the pin puller assembly being operable to pull a pin from a machine, the machine having a frame supporting the pin, wherein the second support member includes a column positionable between the cylinder and the frame, and wherein the coupling assembly is configured to selectively couple the cylinder to one of the first support member, for use of the cylinder assembly in a lifting configuration, and the column, for use of the cylinder assembly in the pin puller assembly.

26. The cylinder assembly of claim 21, wherein the coupling assembly includes a toolless coupling assembly.

27. The cylinder assembly of claim 21, wherein the coupling assembly includes a projection on one of the cylinder or the first support member and the second support member and a recess defined by the other of the cylinder or the first support member and the second support member, the projection being engageable in the recess to selectively connect the cylinder and one of the first support member and the second support member.

28. The cylinder assembly of claim 4, further comprising:
a controller including an electronic processor supported in the housing and configured to control a function of the cylinder assembly; and
an external control device configured to communicate with the controller to control the function.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The cylinder assembly of claim 4, wherein the support member includes a base plate supportable on the work surface to support the cylinder assembly on the work surface, the base plate being connected to the cylinder.

44. The cylinder assembly of claim 43, wherein the base plate has a cylinder portion and a power unit portion, the first end of the cylinder being connected to the cylinder portion, the pump and the motor being supported on the power unit portion.

45. (canceled)

46. The cylinder assembly of claim 44, wherein the support member further includes a cylinder support plate connected to a bottom surface of the cylinder portion of the base plate, and a power unit support plate connected to a bottom surface of the power unit portion of the base plate, the power unit support plate having a webbed construction.

47. The cylinder assembly of 4, wherein the cylinder assembly is configured for use in a pin puller assembly, the pin puller assembly being operable to pull a pin from a machine, the machine having a frame supporting the pin, and wherein the support member includes a column positionable between the cylinder and the frame.

48. (canceled)

49. (canceled)

50. (canceled)

51. The cylinder assembly of claim 4, further comprising a reservoir supported within the housing and configured to contain hydraulic fluid, the pump being in fluid communication with the reservoir.

52. The cylinder assembly of claim 51, wherein the reservoir defines an opening, and wherein the pump includes a pump mechanism positioned at least partially in the reservoir.

53. The cylinder assembly of claim 52, wherein at least a portion of the reservoir is positioned between the cylinder and the pump.

54. The cylinder assembly of claim 53, wherein a first portion of the reservoir is positioned between the cylinder and the pump and a second portion of the reservoir extends along a side of the pump such that the reservoir extends partially around the pump.

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)
